(19) United States
(12) Patent Application Publication
(10) Pub. No.: US 2009/0226201 A1
(43) Pub. Date: Sep. 10, 2009

(54) FIXING DEVICE AND TEMPERATURE CONTROLLING METHOD

(75) Inventors: Satoshi Kinouchi, Shinjyuku-ku (JP); Kazuhiko Kikuchi, Yokohama-shi (JP); Hiroshi Nakayama, Mishima-shi (JP); Toshihiro Sone, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/397,525

(22) Filed: Mar. 4, 2009

Related U.S. Application Data
(60) Provisional application No. 61/034,903, filed on Mar. 7, 2008.

(51) Int. Cl. G03G 15/20

(52) U.S. Cl. 399/69

(57) ABSTRACT

To provide a temperature control technique that can keep temperature distribution in a rotation axis direction of a heating member such as a belt or a heating roller substantially constant more easily than in the past. A fixing device includes: plural heaters that heat plural areas different from one another in the rotation axis direction on a belt; a temperature-information acquiring unit that acquires temperature information concerning temperatures of areas on the belt heated by at least two among the plural heaters; and a heating control unit that alternately drives the respective plural heaters and sets, on the basis of the information acquired by the temperature-information acquiring unit, driving time for the heater that heats a second area having temperature lower than that of a first area among the plural areas longer than driving time for the heater that heats the first area.

### CROSS-REFERENCE TO RELATED APPLICATION

This application is based upon and claims the benefit of priority U.S. provisional application 61/034,903, filed on Mar. 7, 2008, the entire contents of which are incorporated herein by reference.

### TECHNICAL FIELD

The present invention relates to a fixing device, and, more particularly to a fixing device in which a heating member such as a belt or a heating roller is heated in each of different plural areas in a rotation axis direction.

### BACKGROUND

In the past, there is known a technique for heating, in a fixing device, in order to make it possible to maintain temperature distribution in a rotation axis direction of a heating member such as a belt or a heating roller substantially the same, the heating member using plural coils and changing distribution of electric energy among the plural coils to thereby set the temperature distribution substantially the same (JP-A-2000-206813 and JP-A-2001-312178).

However, since electric currents having different frequencies are simultaneously supplied to the respective coils, interference sound occurs.

There is also known a technique for, rather than simultaneously feeding electric currents to plural coils, feeding an electric current to any one of the plural coils to heat a heating member (JP-A-2004-6353). There is also a technique for setting, in feeding an electric current to any one of plural coils to heat a heating member, timing for feeding electric currents to the respective coils to be equal to or larger than a minimum time interval to thereby enable more precise temperature control (JP-A-2004-273454).

However, in order to quicken rise to fixing temperature for toner image fixing and realize a reduction in size of a fixing device, a heating member with a heat capacity reduced from that in the past is used. Therefore, in order to reduce a difference in temperature distribution in a rotation axis direction of such a heating member with the reduced heat capacity, extremely long time is required when the temperature control techniques in the past are used.

### SUMMARY

It is an object of an embodiment of the present invention to provide a temperature control technique that can keep temperature distribution in a rotation axis direction of a heating member such as a belt or a heating roller substantially constant more easily than in the past.

In order solve the problems, according to an aspect of the present invention, there is provided a fixing device including: a heating roller; a stretching and suspending roller that rotates around a rotation axis parallel to a rotation axis of the heating roller; a belt wound and suspended around the heating roller and the stretching and suspending roller; a pressing roller that nips and conveys, in cooperation with the belt, a sheet having a developer image formed thereon and heats and fixes the developer image on the sheet; plural heaters that heat plural areas different from one another in the rotation axis direction on the belt; a temperature-information acquiring unit that acquires temperature information concerning temperatures of areas on the belt heated by at least two among the plural heaters; and a heating control unit that alternately drives the respective plural heaters and sets, on the basis of the information acquired by the temperature-information acquiring unit, driving time for the heater that heats a second area having temperature lower than that of a first area among the plural areas longer than driving time for the heater that heats the first area.

According to another aspect of the present invention, there is provided a fixing device including: a heating roller; a pressing roller that nips and conveys, in cooperation with the heating roller, a sheet having a developer image formed thereon and heats and fixes the developer image on the sheet; plural heaters that heat plural areas different from one another in a rotation axis direction of the heating roller; a temperature-information acquiring unit that acquires temperature information concerning temperatures of areas on the heating roller heated by at least two among the plural heaters; and a heating control unit that alternately drives the respective plural heaters and sets, on the basis of the information acquired by the temperature-information acquiring unit, driving time for the heater that heats a second area having temperature lower than that of a first area among the plural areas longer than driving time for the heater that heats the first area.

According to still another aspect of the present invention, there is provided a temperature control method in a fixing device including a heating roller, a stretching and suspending roller that rotates around a rotation axis parallel to a rotation axis of the heating roller, a belt wound and suspended around the heating roller and the stretching and suspending roller, a pressing roller that nips and conveys, in cooperation with the belt, a sheet having a developer image formed thereon and heats and fixes the developer image on the sheet, and plural heaters that heat plural areas different from one another in the rotation axis direction on the belt, the temperature control method including: acquiring temperature information concerning temperatures of areas on the heating roller heated by at least two among the plural heaters; and alternately driving the respective plural heaters and setting, on the basis of the acquired temperature information, driving time for the heater that heats a second area having temperature lower than that of a first area among the plural areas longer than driving time for the heater that heats the first area.

According to still another aspect of the present invention, there is provided a temperature control program in a fixing device including a heating roller, a stretching and suspending roller that rotates around a rotation axis parallel to a rotation axis of the heating roller, a belt wound and suspended around the heating roller and the stretching and suspending roller, a pressing roller that nips and conveys, in cooperation with the belt, a sheet having a developer image formed thereon and heats and fixes the developer image on the sheet, and plural heaters that heat plural areas different from one another in the rotation axis direction on the belt, the temperature control program causing a computer to execute processing for: acquiring temperature information concerning temperatures of areas on the belt heated by at least two among the plural heaters; and alternately driving the respective plural heaters and setting, on the basis of the acquired temperature information, driving time for the heater that heats a second area having temperature lower than that of a first area among the plural areas longer than driving time for the heater that heats the first area.

### DESCRIPTION OF THE DRAWINGS

FIG. 1 is a longitudinal sectional view of a schematic configuration of an image forming apparatus mounted with a fixing device according to a first embodiment of the present invention;

FIG. 2 is a longitudinal sectional view of a schematic configuration of the fixing device according to the first embodiment;

FIG. 3 is a front view of a schematic configuration in a belt rotation axis direction of the fixing device according to the first embodiment;

FIG. 4 is a block diagram of an electric configuration for control of temperature detection, excitation coils, and an oscillation circuit (an inverter circuit) of the fixing device according to the first embodiment;

FIG. 5 is a functional block diagram for explaining functions of the fixing device according to the first embodiment;

FIG. 6 is a driving control table corresponding to warm-up and ready states in the fixing device according to the first embodiment;

FIG. 7 is a driving control table corresponding to a paper passing state in the fixing device according to the first embodiment;

FIG. 8 is a flowchart of processing of excitation coil driving control corresponding to an operation state of the image forming apparatus mounted with the fixing device according to the first embodiment;

FIG. 9 is a flowchart of processing of excitation coil driving control in the warm-up state of the image forming apparatus mounted with the fixing device according to the first embodiment;

FIG. 10 is a flowchart of processing of electric energy control for the excitation coils in the ready state of the image forming apparatus mounted with the fixing device according to the first embodiment;

FIG. 11 is a flowchart of processing of electric energy control for the excitation coils in the paper passing state of the image forming apparatus mounted with the fixing device according to the first embodiment;

FIG. 12 is a flowchart of processing of excitation coil driving control in the paper passing state of the image forming apparatus mounted with the fixing device according to the first embodiment;

FIG. 13 is a flowchart of processing of excitation coil driving control corresponding to an operation state of an image forming apparatus mounted with a fixing device according to a second embodiment of the present invention;

FIG. 14 is a flowchart of processing of excitation coil driving control at conveying speed of 135 m/s in a paper passing state of the image forming apparatus mounted with the fixing device according to the second embodiment;

FIG. 15 is a driving control table corresponding to conveying speed of 135 m/s in the fixing device according to the second embodiment;

FIG. 16 is a flowchart of processing of excitation coil driving control corresponding to an operation state of an image forming apparatus mounted with a fixing device according to a third embodiment of the present invention;

FIG. 17 is a flowchart of processing of excitation coil driving control in a paper passing state of the image forming apparatus mounted with the fixing device according to the third embodiment in which twenty or more small-size sheets are continuously passed;

FIG. 18 is a driving control table corresponding to continuous paper passing of twenty or more small-size sheets in the fixing device according to the third embodiment;

FIG. 19 is a functional block diagram for explaining functions of a fixing device according to a fourth embodiment of the present invention;

FIG. 20 is a flowchart of processing of excitation coil driving control corresponding to internal temperature of an image forming apparatus mounted with the fixing device according to the fourth embodiment;

FIG. 21 is a flowchart of processing of excitation coil driving control at internal temperature equal to or lower than 10° C. of the image forming apparatus mounted with the fixing device according to the fourth embodiment;

FIG. 22 is a flowchart of processing of excitation coil driving control at internal temperature higher than 10° C. of the image forming apparatus mounted with the fixing device according to the fourth embodiment;

FIG. 23 is a driving control table corresponding to internal temperature equal to or lower than 10° C. of the image forming apparatus in the fixing device according to the fourth embodiment;

FIG. 24 is a driving control table corresponding to internal temperature higher than 10° C. of the image forming apparatus in the fixing device according to the fourth embodiment;

FIG. 25 is a front view of a schematic configuration in a belt rotation axis direction of a fixing device according to a fifth embodiment of the present invention; and

FIG. 26 is a front view of a schematic configuration on the belt rotation axis direction of the fixing device according to the fifth embodiment.

### DETAILED DESCRIPTION

Embodiments of the present invention are explained below with reference to the accompanying drawings.

### First Embodiment

First, a first embodiment of the present invention is explained.

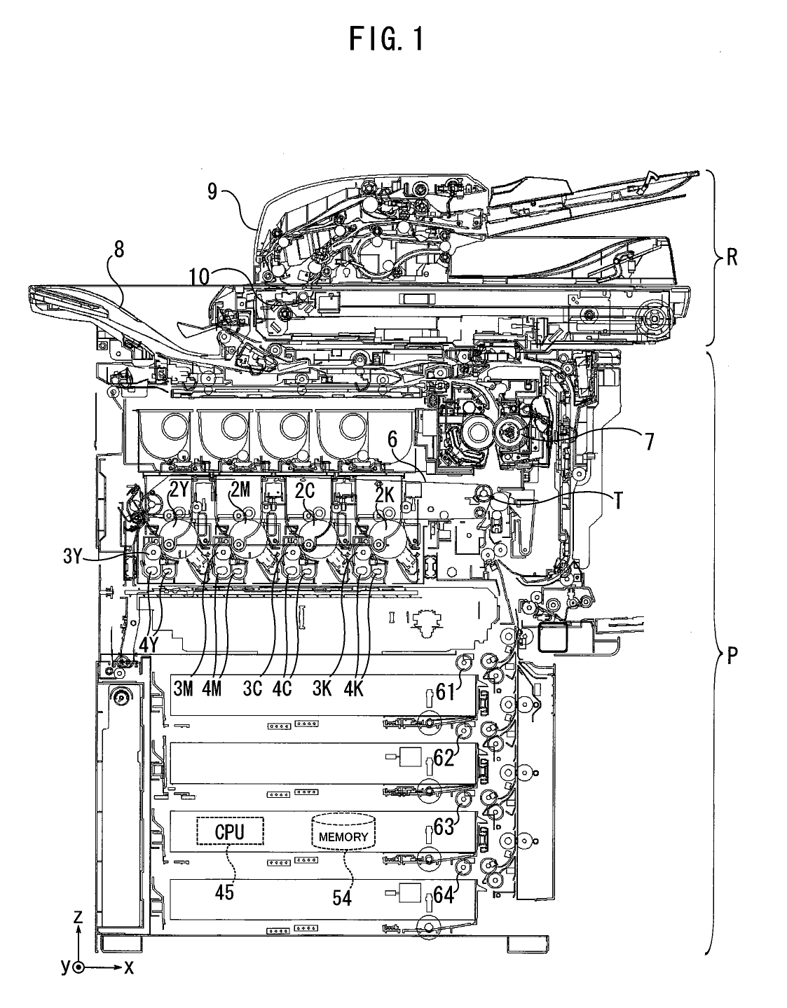

FIG. 1 is a longitudinal sectional view of a schematic configuration of an image forming apparatus (Multi Function Peripheral (MFP)) mounted with a fixing device according to the first embodiment of the present invention.

As shown in FIG. 1, the image forming apparatus according to this embodiment includes an image scanning unit R and an image forming unit P.

The image scanning unit R has a function of scanning an image of a sheet original document and a book original document.

The image forming unit P has a function of forming a developer image on a sheet on the basis of an image scanned from an original document by the image scanning unit R, image data transmitted from an external apparatus to the image forming apparatus, and the like.

The image scanning unit R includes an auto document feeder (ADF) 9 that can automatically feed an original document to a predetermined image scanning position. The image scanning unit R scans, using a scanning optical system 10, images of an original document automatically fed by the auto document feeder 9 and an original document placed on a document table.

The image forming unit P includes pickup rollers 61 to 64, photoconductive members 2Y to 2K, developing rollers 3Y to 3K, mixers 4Y to 4K, an intermediate transfer belt 6, a fixing device 7, and a discharge tray 8.

A CPU 45 has a role of performing various kinds of processing in the image processing apparatus and also has a role of realizing various functions by executing programs stored in a memory 54.

The memory 54 can be, for example, a RAM (Random Access Memory), a ROM (Read Only Memory), a DRAM (Dynamic Random Access Memory), an SRAM (Static Random Access Memory), or a VRAM (Video RAM). The memory 54 has a role of storing various kinds of information and programs that are used in the image processing apparatus.

As an example of the fixing device according to this embodiment, an overview of copy processing in the image forming apparatus mounted with the fixing device is explained.

First, sheets picked up from cassettes by the pickup rollers 61 to 64 are fed into a sheet conveying path. The sheets fed into the sheet conveying path are conveyed in a predetermined conveying direction by plural roller pairs.

Images of plural sheet original documents automatically conveyed continuously by the auto document feeder 9 are scanned by the scanning optical system 10 in the predetermined image scanning position.

On the basis of image data of the images scanned from the original documents by the image scanning unit R, electrostatic latent images are formed on photoconductive surfaces of the photoconductive members 2Y, 2M, 2C, and 2K for transferring developer images of yellow (Y), magenta (M), cyan (C), and black (K) onto the sheets.

Subsequently, developers agitated by the mixers 4Y to 4K (equivalent to agitating units) in a developing device are supplied to the photoconductive members 2Y to 2K, on which the electrostatic latent images are formed as explained above, by the developing rollers (so-called mug rollers) 3Y to 3K. Consequently, the electrostatic latent images formed on the photoconductive surfaces of the photoconductive members 2Y, 2M, 2C, and 2K are visualized.

Developer images formed on the photoconductive members 2Y, 2M, 2C, and 2K in this way are transferred onto a belt surface of the intermediate transfer belt 6 (so-called primary transfer). The developer images carried according to the rotation of the intermediate transfer belt 6 are transferred on to the conveyed sheets in a predetermined secondary transfer position T.

The developer images transferred onto the sheets are heated and fixed on the sheets by the fixing device 7.

The sheets on which the developer images are heated and fixed are conveyed through a conveying path by plural conveying roller pairs and sequentially discharged onto the discharge tray 8.

Details of the fixing device 7 according to the first embodiment are explained below.

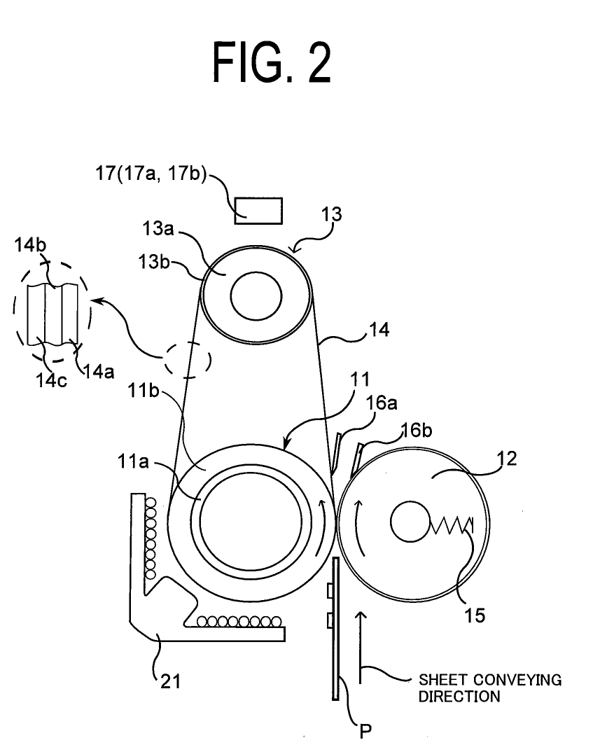

FIG. 2 is a sectional view of a schematic configuration of the fixing device 7 according to the first embodiment.

The fixing device 7 includes a heating roller 11 (φ 50 mm), a pressing roller 12 (φ 50 mm), a stretching and suspending roller 13 (φ 18 mm), a belt 14, and a heating unit 21.

The pressing roller 12 is driven in an arrow direction by a driving motor (not shown). The heating roller 11, the stretching and suspending roller 13, and the belt 14 are driven to rotate in the arrow direction. The pressing roller 12 is set in press contact with the heating roller 11 across the belt 14 by a pressing mechanism 15 and maintained to have fixed nip width. Therefore, in the first embodiment, the heating roller 11 does not come into direct contact with a sheet.

The stretching and suspending roller 13 is arranged further on a downstream side in a sheet conveying direction than the heating roller 11 and rotates around a rotation axis parallel to a rotation axis of the heating roller 11. The belt 14 is wound and suspended between the heating roller 11 and the stretching and suspending roller 13 with predetermined tension by a tension mechanism. Heating parts 48 are arranged over the periphery of the heating roller and heat the belt 14.

The heating roller 11 includes, in order from an inner side, a core bar 11a and foamed rubber (sponge) 11b. In the first embodiment, core bar thickness is set to 2 mm and foamed rubber thickness is set to 5 mm.

The belt 14 includes, in order from an inner side, a metal conductive layer 14a, a solid rubber layer 14b, and a release layer 14c. In the first embodiment, nickel (40 μm) is used as a material of the metal conductive layer 14a. Besides, stainless steel, aluminum, a composite material of stainless steel and aluminum, and the like may be used. In the first embodiment, the solid rubber layer 14b is formed of 200 μm of silicon rubber and the release layer 14c is formed of 30 μm of a PFA tube.

The pressing roller 12 is configured by coating a core bar with silicon rubber, fluorine rubber, or the like.

The stretching and suspending roller 13 is configured by coating the surface of a metal pipe 13a with a coating layer 13b. As a material of the metal pipe 13a, in this embodiment, aluminum is used. However, the material may be iron, copper, stainless steel, and the like. A heat pipe and the like having higher thermal conductivity may be used instead of the metal pipe 13a.

When a sheet P passes a fixing point as a press contact portion (a nip portion) between the heating roller 11 and belt 14 and the pressing roller 12, a developer on the sheet is fused and pressed to be fixed.

A peeling blade 16a that peels the sheet P from a belt surface of the belt 14 is provided further on a downstream side in a rotating direction than a contact position (the nip portion) between the belt 14 and the pressing roller 12. A peeling blade 16b that peels the sheet P from the pressing roller 12 is provided further on the downstream side in the rotating direction than the nip portion.

Plural non-contact temperature sensors 17 (17a and 17b) are arranged in a position near the belt 14 on the stretching and suspending roller 13 and different from one another in the rotation axis direction of the stretching and suspending roller 13. Although the two sensors are arranged in the first embodiment as an example, three or more sensors maybe arranged. In the first embodiment, as the non-contact temperature sensors 17, a thermopile type for detecting an infrared ray is used. The non-contact temperature sensors 17, more specifically, a thermopile 17a and a thermopile 17b detect temperatures of plural heating target areas on the surface of the belt 14.

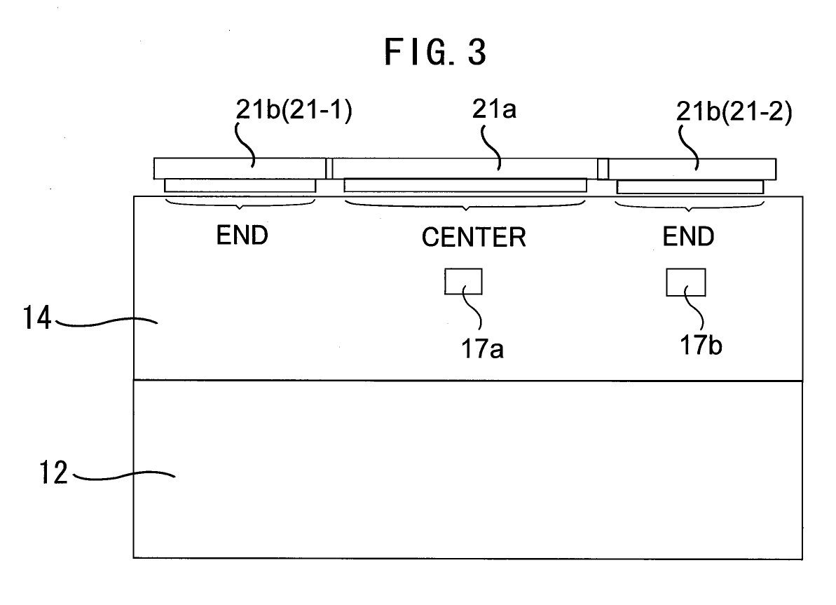

A configuration of the heating unit 21 according to the first embodiment is specifically explained (FIG. 3).

The heating unit 21 is an induction heating member including plural excitation coils (21a, 21-1, and 21-2).

As shown in FIG. 3, as the heating unit 21, an induction heating type for performing heating making use of electromagnetic induction is used. In the heating unit 21, an excitation coil (an electromagnetic induction coil) is divided into three areas in one rotation axis direction. End coils 21-1 and 21-2 except a center coil 21a are connected in series. The end coils 21-1 and 21-2 are described as end coils 21b below.

The coils 21a and 21b intensify a magnetic field using a magnetic core 22 such that the coils 21a and 21b can display performance even if the number of windings of an electric wire is reduced.

Magnetic fluxes can be concentrated by this coil shape. The belt 14 is locally concentratedly heated.

In this embodiment, the belt 14 is heated by alternately driving the plural coils 21a and 21b (so-called alternate lighting). Driving of the coils is explained later.

The configuration of the excitation coils is more specifically explained. As the excitation coils 21a and 21b, a copper wire material having the diameter of 0.5 mm is used. The excitation coils 21a and 21b are formed as litz wires obtained by binding plural wire materials insulated from one another. Since the excitation coils 21a and 21b are formed as the litz wires, it is possible to further reduce the wire diameter to be smaller than penetration depth and effectively feed an alternating current. In the first embodiment, sixteen wire materials having the diameter φ 0.5 mm are bound. As a coating wire for the coils, heat-resistant polyamide-imide is used.

In the first embodiment, magnetic fluxes and eddy-currents are generated on the belt 14 to prevent a change in a magnetic field by magnetic fluxes generated by a high-frequency current applied the excitation coils 21a and 21b from a not-shown excitation circuit (an inverter circuit). Joule heat is generated by the eddy-currents and heating roller resistance and the belt 14 is heated. In the first embodiment, an electric current having a high frequency in a range of 20 to 100 kHz is fed to the excitation coils 21a and 21b. An output can be changed from 200 W to 1500 W by changing a driving frequency of the inverter circuit.

The excitation coils 21a and 21b respectively heat the plural heating target areas on the belt 14. In this specification, an area heated by the excitation coil 21a is referred to as “center” and areas heated by the excitation coils 21b are referred to as “ends”. When the center coil 21a is driven, an eddy-current is generated in the center of the belt 14, the center of the belt 14 is heated by Joule heat, and the temperature thereof rises. On the other hand, when the end coils 21b are driven, eddy-currents are generated at the ends of the belt 14, the ends of the belt 14 are heated by Joule heat, and the temperature thereof rises.

In the first embodiment, according to detected temperatures in the thermopiles 17a and 17b as temperature sensors, the coils 21a and 21b are selectively switched and driven to raise the temperature of the belt 14, whereby control temperature for fixing is maintained.

When the belt 14 is heated, usually, the belt 14 is rotated together with the pressing roller 12, the heating roller 11, and the stretching and suspending roller 13.

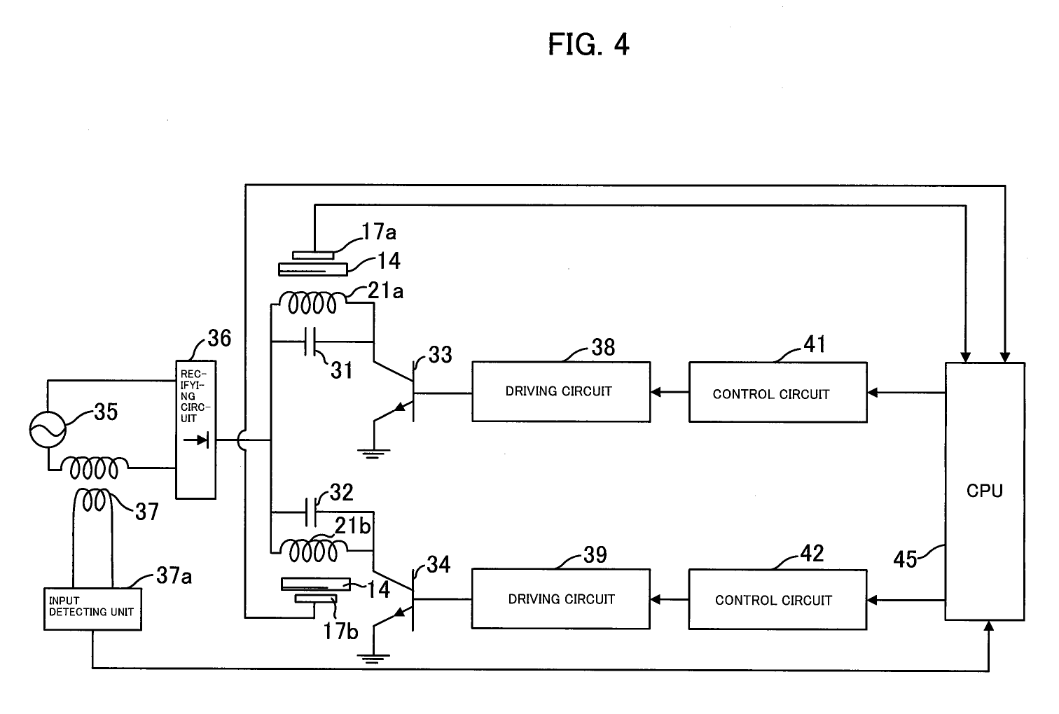

FIG. 4 is a diagram of an overview of an electric configuration concerning a control method for temperature detection, the excitation coils, and an oscillation circuit (an inverter circuit).

In the first embodiment, capacitors 31 and 32 for resonance are connected to the excitation coils 21a and 21b shown in FIG. 1 in parallel to each other. Switching elements 33 and 34 are connected to this resonant circuit to configure an inverter circuit. As the switching elements 33 and 34, IGBT (Insulated Gate Bipolar Transistor), MOS-FET, or the like used under high withstanding pressure and large current is used. In the first embodiment, IGBT is used.

DC power obtained by smoothing a commercial AC power supply 35 with a rectifying circuit 36 is supplied to the inverter circuit. A transformer 37 is arranged at a pre-stage of the rectifying circuit 36. Total power consumption can be detected via the input detecting unit 37a. Electric power is fed back by this power detection.

Driving circuits 38 and 39 are connected to control terminals of the switching elements 33 and 34, respectively. The driving circuits 38 and 39 apply driving voltage to the control terminals of the switching elements 33 and 34 to turn on the switching elements. Control circuits 41 and 42 output timing for the application of the driving voltage. The control circuits 41 and 42 control ON time, change a frequency in a range of 20 to 100 kHz, and change an output value.

The thermopiles 17a and 17b that detect temperature as explained above are arranged in a heated object (in the first embodiment, the belt 14) heated by the coils 21a and 21b. Temperature detection signals (voltage values) of the thermopiles are input to the CPU 45. According to values of the thermopiles 17a and 17b, the CPU 45 sends, to the control circuits 41 and 42, a command for instructing which coil (21a or 21b) should be driven, whether all the coils (21a and 21b) should be turned off, and to which value an output value should be set.

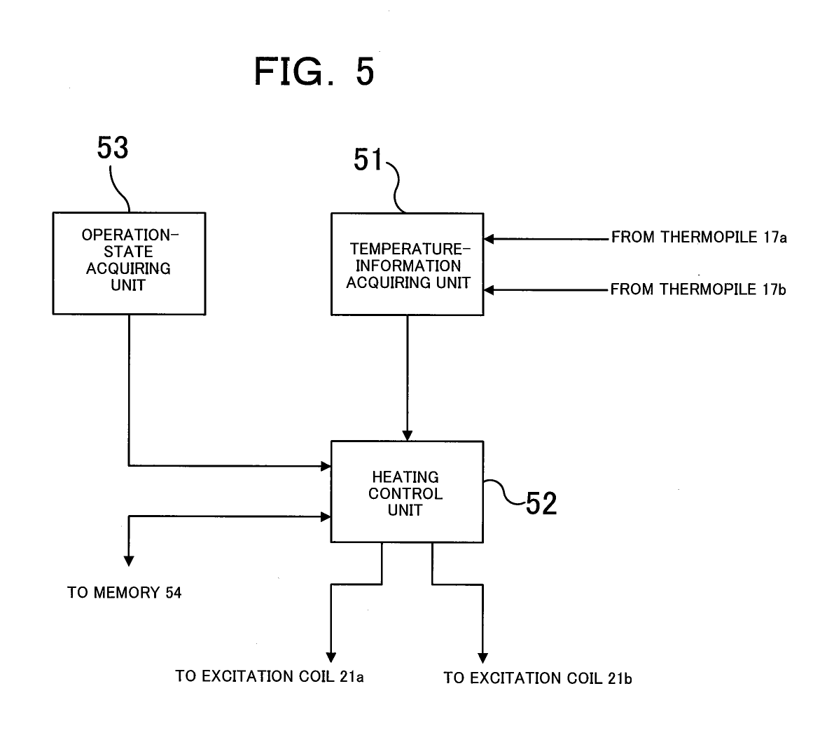

Functions related to driving control for the excitation coils of the fixing device according to the first embodiment are explained with reference to FIG. 5. Functions of respective blocks in a functional block diagram shown in FIG. 5 are realized by causing the CPU 45 to execute, for example, various computer programs stored in the memory 54.

As shown in FIG. 5, the driving control for the excitation coils of the fixing device according to the first embodiment is performed by a temperature-information acquiring unit 51, a heating control unit 52, and an operation-information acquiring unit 53.

The temperature-information acquiring unit 51 acquires, as temperature information, the temperature of the belt 14 detected by the thermopiles 17, more specifically, the thermopile 17a that detects the temperature in the center of the belt 14 and the thermopile 17b that detects the temperature at the ends of the belt 14, and sends the temperature information to the heating control unit 52.

The operation-information acquiring unit 53 acquires information concerning an operation state such as a warm-up state, a ready state, or a paper passing state of an image forming apparatus 1 mounted with the fixing device 7 according to the first embodiment from the inside or the outside of the image forming apparatus 1 and sends the information to the heating control unit 52.

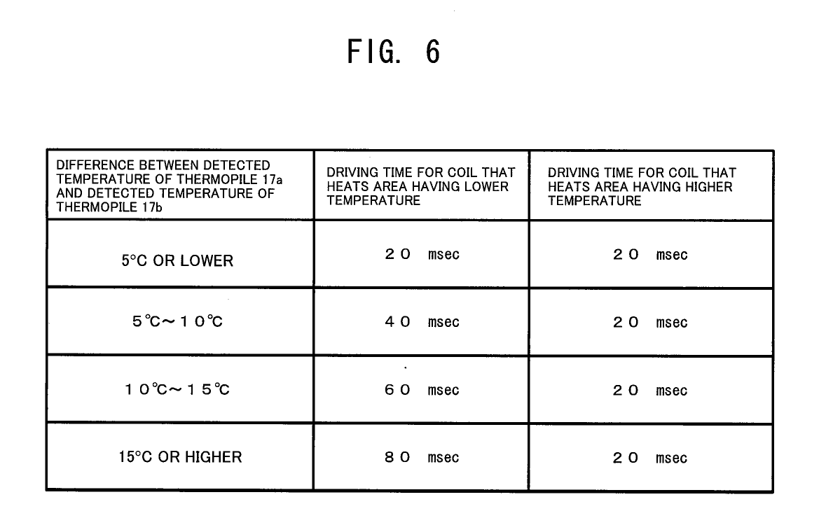

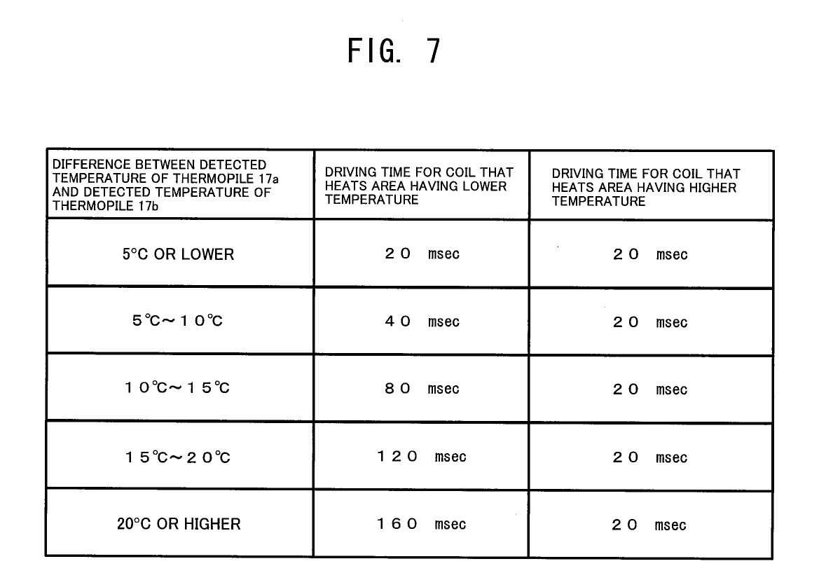

Driving control tables concerning driving times for the excitation coils associated with temperature differences between the center of the belt 14 heated by the excitation coil 21a and the ends of the belt 14 heated by the excitation coils 21b (21-1 and 21-2) and the operation states of the image forming apparatus 1 are stored in the memory 54. A driving control table in the warm-up and ready states of the image forming apparatus 1 as an example of the driving control table is shown in FIG. 6. A driving control table in the paper passing state of the image forming apparatus 1 is shown in FIG. 7.

The heating control unit 52 controls driving of the excitation coils 21a and 21b of the heating unit 21 on the basis of the temperature information acquired from the temperature-information acquiring unit 51 and the information concerning the operation state of the image forming apparatus 1 acquired from the operation-information acquiring unit 53 to thereby control temperature in the rotation axis direction of the belt 14. Specifically, the heating control unit 52 alternately drives the excitation coils 21a and 21b of the heating unit 21 and sets, on the basis of the temperature information acquired by the temperature-information acquiring unit 51, driving time for the excitation coil(s) that heats (heat) a second area (one of the center and the ends) having temperature lower than that of a first area (the other of the center and the ends) on the surface of the belt 14 longer than driving time for the excitation coil(s) that heats (heat) the first area.

An example of the temperature control by the heating control unit 52 is more specifically explained. First, the heating control unit 52 determines an operation state of the image forming apparatus 1 on the basis of the information concerning the operation state of the image forming apparatus 1 acquired from the operation-information acquiring unit 53. Subsequently, the heating control unit 52 calculates a temperature difference between the first area and the second area of the belt 14 on the basis of the temperature information acquired from the temperature-information acquiring unit 51. On the basis of the calculated temperature difference and the operation state of the image forming apparatus 1 and referring to the driving control tables stored in the memory 54, the heating control unit 52 selects, as driving time for the excitation coils that heat the first and second areas, driving time associated with the temperature difference and the operation state among plural kinds of driving times set as driving times of the excitation coils that heat the first and second areas.

In the first embodiment, concerning plural kinds of driving times for the excitation coil(s) that heats (heat) the second area having temperature lower than that of the first area on the surface of the belt 14, driving time for the excitation coil(s) that heats (heat) the second area is set longer as operation states associated with the plural kinds of driving times have a larger degree of causing a temperature difference between the areas in the rotation axis direction on the belt 14. For example, in the paper passing state, a degree of causing a temperature difference is large compared with those in the warm-up and ready states. Therefore, as shown in FIGS. 6 and 7, even when a temperature difference is in the same range, it is preferable to set driving time for the excitation coil(s) that heats (heat) the second area corresponding to the paper passing state longer than driving time for the excitation coil(s) that heats (heat) the second area corresponding to the warm-up state and the read state.

As explained above, driving time for the excitation coil(s) that heats (heat) an area having lower temperature in the paper passing state is set longer than driving time for the excitation coils(s) in the warm-up and the ready state. This is explained more in detail below.

During paper passing, a ratio of a heat quantity deprived in the rotation axis direction of the belt 14 in the fixing device 7 substantially changes according to a size of a sheet subjected to fixing and conveyed. When a sheet having width far smaller than the width of the belt 14 in the rotation axis direction such as an A4R, A5, or B5 sheet is passed, heat is deprived on the belt 14 differently in the center and at the ends.

More specifically, a sheet of the size A4R, B5, A5, or the like relatively small in the rotation axis direction comes into contact with only the center in the rotation axis direction of the belt 14 as a paper passing area. Therefore, the temperature in the center tends to be low compared with those at the ends. The temperature at the ends on the belt 14 tends to be higher than control temperature explained later.

Therefore, when the image forming apparatus 1 is in the paper passing state, the temperature difference rather increases even if the driving control table corresponding to the warm-up and ready states is used.

Therefore, in the first embodiment, driving time corresponding to the paper passing state is set longer than driving times corresponding to the warm-up and ready states. Further, in the first embodiment, driving time at a temperature difference equal to or larger than 20° C. is set in the driving control table corresponding to the paper passing state.

Consequently, it is possible to keep temperature distribution in the rotation axis direction of the belt 14 substantially constant even when a small-size sheet is passed.

An example of a flowchart of processing by the fixing device 7 according to the first embodiment is explained.

The heating control unit 52 determines, according to an operation state of the image forming apparatus 1, based on which of the driving control tables stored in the memory 54 driving control for the excitation coils 21a and 21b of the heating unit 21 should be performed.

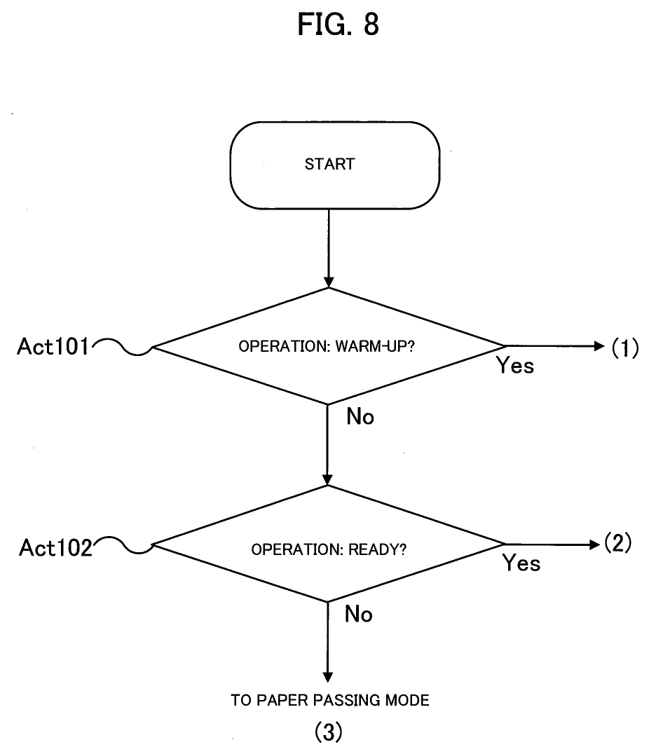

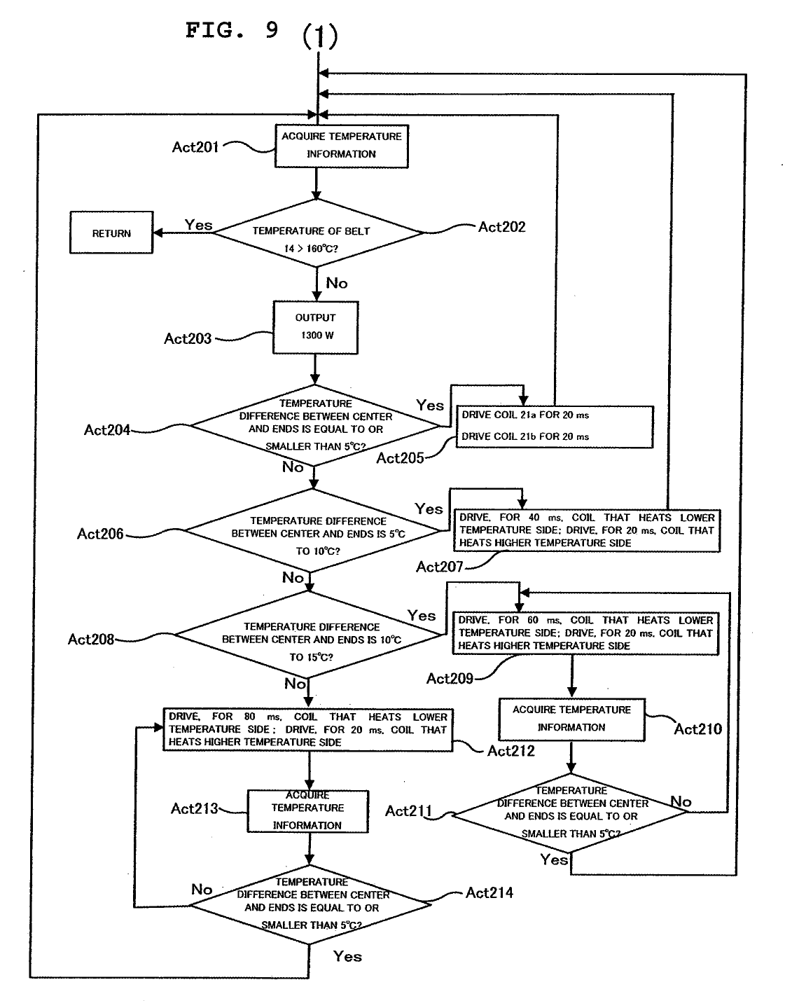

Specifically, as shown in FIG. 8, in Act 101, the heating control unit 52 determines, on the basis of information concerning an operation state of the image forming apparatus 1 acquired from the operation-information acquiring unit 53, whether the operation state of the image forming apparatus 1 is the warm-up state. If the operation state of the image forming apparatus 1 is the warm-up state, the heating control unit 52 proceeds to (1) and performs, on the basis of processing of a flowchart shown in FIG. 9, driving control for the excitation coils 21a and 21b of the heating unit 21 using the driving control table corresponding to the warm-up and ready states.

If it is determined in Act 101 that the operation state of the image forming apparatus 1 is not the warm-up state, in Act 102, the heating control unit 52 determines, on the basis of the information concerning the operation state of the image forming apparatus 1 acquired from the operation-information acquiring unit 53, whether the operation state of the image forming apparatus 1 is the ready state. If the operation state of the image forming apparatus 1 is the ready state, the heating control unit 52 proceeds to (2) and performs, on the basis of the processing of the flowchart shown in FIG. 9, driving control for the excitation coils 21a and 21b of the heating unit 21 using the driving control table corresponding to the warm-up and ready states.

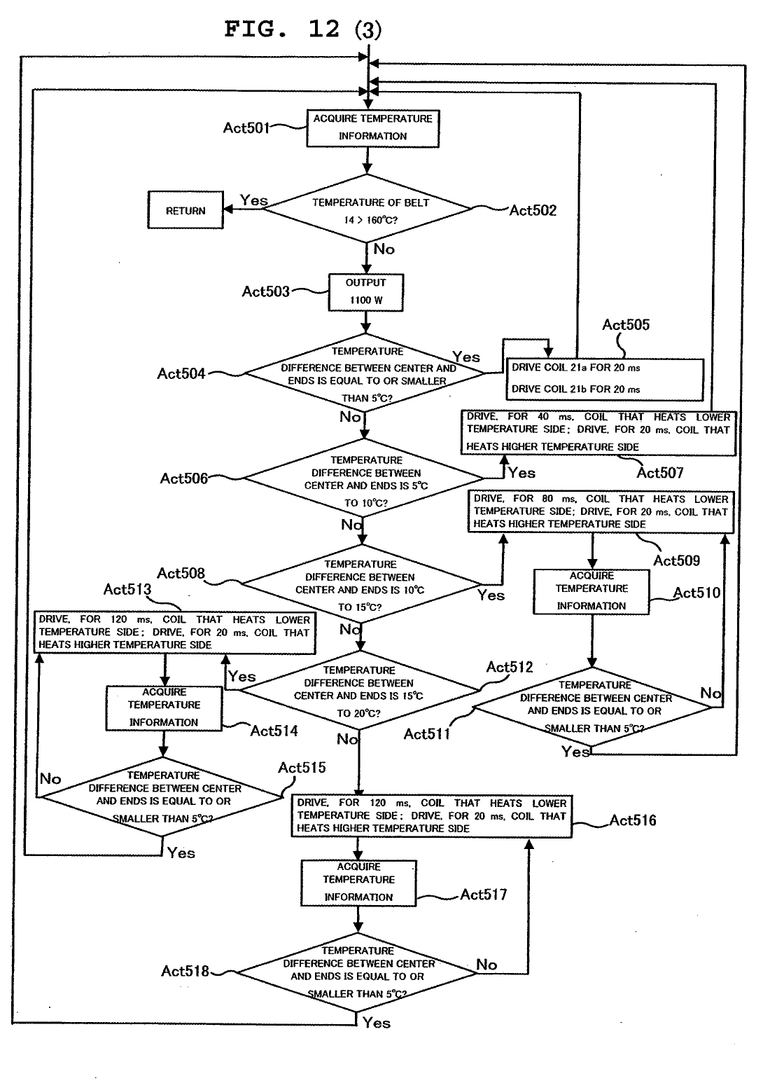

On the other hand, if it is determined in Act 102 that the operation state of the image forming apparatus 1 is not the ready state, the heating control unit 52 proceeds to (3), determines that the image forming apparatus 1 is in the paper passing state, and performs, on the basis of processing of a flowchart shown in FIG. 12, driving control for the excitation coils 21a and 21b of the heating unit 21 using the driving control table corresponding to the paper passing state.

Driving control for the excitation coils 21a and 21b of the heating unit 21 in the warm-up state of the image forming apparatus 1 is explained in detail with reference to FIG. 9.

First, in Act 201, the temperature-information acquiring unit 51 acquires, as temperature information, the temperature of the belt 14 detected by the thermopiles 17a and 17b and sends the temperature information to the heating control unit 52. In Act 202, the heating control unit 52 determines, on the basis of the temperature information acquired by the temperature-information acquiring unit 51, whether the temperature of the belt 14 detected by the thermopiles 17a and 17b reaches control temperature (in the first embodiment, 160° C.). In the first embodiment, the detection of temperature is executed by the CPU 45 at every 200 (ms).

If the temperature exceeds 160° C. at this point, the image forming apparatus 1 finishes the warm-up state and enters (returns to) the ready.

If the temperature does not exceed 160° C. in Act 202, first, in Act 203, the heating control unit 52 sets an output of the heating unit 21 to 1300 W. Subsequently, in Act 204, the heating control unit 52 executes, on the basis of the temperature information of the belt 14, comparison of temperatures in the center and at the ends of the belt 14 detected by the thermopiles 17a and 17b. The heating control unit 52 selects, on the basis of a result of the temperature comparison, driving time for each of the temperature differences set in the driving control tables and performs driving control for the excitation coils 21a and 21b of the heating unit 21.

Specifically, processing can be performed as explained below on the basis of the driving control table shown in FIG. 6.

First, in Act 204, the heating control unit 52 determines whether a temperature difference between the center and the ends of the belt 14 is equal to or smaller than 5° C. If it is determined that the temperature difference is equal to or smaller than 5° C., the heating control unit 52 alternately drives the excitation coils 21a and 21b of the heating unit 21 for 20 ms (Act 205). The heating control unit 52 returns to Act 201 and repeats the processing until it is determined in Act 202 that the temperature of the belt 14 reaches 160° C.

If it is determined in Act 204 that the temperature difference between the center and the ends of the belt 14 is larger than 5° C., the heating control unit 52 proceeds to Act 206 and determines whether the temperature difference between the center and the ends is 5 to 10° C. If it is determined that the temperature difference is 5 to 10° C., the heating control unit 52 drives, for 40 ms, the excitation coil(s) that heats (heat) a side determined as having lower temperature (in the first embodiment, one of the center and the ends and equivalent to the second area) among the excitation coils 21a and 21b of the heating unit 21. The heating control unit 52 drives, for 20 ms, the excitation coil(s) that heats (heat) a side determined as having higher temperature (in the first embodiment, the other of the center and the ends and equivalent to the first area) (Act 207). The heating control unit 52 returns to Act 201 and repeats the processing until it is determined in Act 202 that the temperature of the belt 14 reaches 160° C.

If it is determined in Act 206 that the temperature difference between the center and the ends of the belt 14 is larger than 10° C., the heating control unit 52 proceeds to Act 208 and determines whether the temperature difference between the center and the ends of the belt 14 is 10 to 15° C. If it is determined that the temperature difference is 10 to 15° C., the heating control unit 52 drives, for 60 ms, the excitation coils that heat the side determined as having lower temperature among the excitation coils 21a and 21b of the heating unit 21 (Act 209). Further, the heating control unit 52 drives, for 20 ms, the excitation coil that heats the side determined as having higher temperature (Act 209). The driving of the excitation coils 21a and 21b of the heating unit 21 that heats the belt 14 is alternately performed. The temperature-information acquiring unit 51 acquires temperature information of the belt 14 (Act 210). Subsequently, the heating control unit 52 determines, on the basis of the acquired temperature information, whether a temperature difference between the center and the ends of the belt 14 is equal to or smaller than 5° C. (Act 211). If it is determined that the temperature difference between the center and the ends is larger than 5° C., the heating control unit 52 returns to Act 209 and repeats the processing. On the other hand, if it is determined that the temperature difference between the center and the ends is equal to or smaller than 5° C., the heating control unit 52 returns to Act 201 and repeats the processing until it is determined in Act 202 that the temperature of the belt 14 reaches 160° C.

If it is determined in Act 208 that the temperature difference between the center and the ends of the belt 14 is larger than 15° C., the heating control unit 52 drives, for 80 ms, the excitation coils that heat the side determined as having lower temperature among the excitation coils 21a and 21b of the heating unit 21 (Act 212). Further, the heating control unit 52 drives, for 20 ms, the excitation coil that heats the side determined as having higher temperature (Act 212). Subsequently, the temperature-information acquiring unit 51 acquires temperature information of the belt 14 (Act 213). The heating control unit 52 determines, on the basis of the acquired temperature information, whether a temperature difference between the center and the ends of the belt 14 is equal to or smaller than 5° C. (Act 214). If it is determined that the temperature difference between the center and the ends of the belt 14 is larger than 5° C., the heating control unit 52 returns to Act 212 and repeats the processing. On the other hand, if it is determined that the temperature difference between the center and the ends is equal to or smaller than 5° C., the heating control unit 52 returns to Act 201 and repeats the processing until it is determined in Act 202 that the temperature of the belt 14 reaches 160° C.

As a result of performing the processing explained above, when the temperature of the belt 14 exceeds 160° C., the image forming apparatus 1 finishes the warm-up state and shifts the operation state to the ready (returns to the ready).

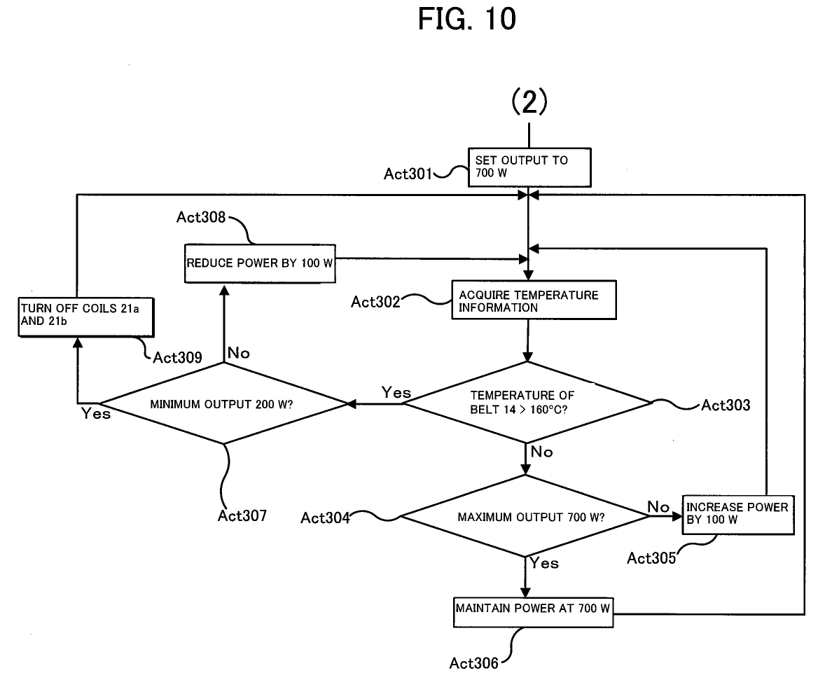

A flowchart indicating a flow of processing of power control for the excitation coils 21a and 21b of the heating unit 21 in the ready state of the image forming apparatus 1 is explained with reference to FIG. 10.

When the image forming apparatus 1 is in the ready state, the fixing apparatus 7 according to the first embodiment uses a driving control table same as that used in the warm-up state.

The ready state is different from the warm-up state in that, in the ready state, the CPU 45 sends a command for reducing electric power (output) to both the control circuits 41 and 42 to maintain the control temperature (160° C.). In other words, the CPU 45 reduces ON time of the switching elements and reduces electric power to control the temperature of the belt 14 to be equal to or lower than 160° C.

Concerning an output of the heating unit 21, in the case of the warm-up state, the center coil and the side coils are driven at a frequency for heating at 1300 W. In the case of the ready state, the center coil and the side coils are driven at a frequency for heating at MAX 700 W. Since the temperature of the belt 14 already reaches the control temperature (160° C.), a large heat quantity is not required. Therefore, a heat quantity is limited to be equal to or smaller than 700 W. In order to maintain the temperature of the belt 14 at the control temperature 160° C., electric power is gradually reduced. When the temperatures in the center and at the ends exceed 160° C. even if the heat quantity decreases to a minimum output 200 W, the heating unit 21 is turned off.

An example of a flowchart for changing electric power according to the first embodiment is shown in FIG. 10.

In Act 301, first, the CPU 45 sets output power of the excitation coils 21a and 21b of the heating unit 21 to 700 W. Subsequently, in Act 302, the CPU 45 acquires temperatures in the center and at the ends of the belt 14 detected by the thermopiles 17a and 17b and determines whether the temperature of the belt 14 is higher than 160° C.

If it is determined in Act 303 that the temperature of the belt 14 is equal to or lower than 160° C., the CPU 45 proceeds to Act 304 and determines whether electric energy is the maximum output 700 W.

If it is determined in Act 304 that the electric energy is not 700 W, the CPU 45 proceeds to Act 305 and increases the electric energy by a predetermined value (e.g., 100 W). The CPU 45 returns to Act 302 and repeats the processing.

On the other hand, if it is determined in Act 304 that the electric energy is 700 W, the CPU 45 proceeds to Act 306 and maintains the electric energy at 700 W. The CPU 45 returns to Act 302 and repeats the processing.

If it is determined in Act 303 that the temperature of the belt 14 is higher than 160° C., the CPU 45 proceeds to Act 307 and determines whether the electric energy is the minimum output 200 W.

If it is determined in Act 307 that the electric energy is not 200 W, the CPU 45 proceeds to Act 308 and reduces the electric energy by a predetermined value (e.g., 100 W). The CPU 45 returns to Act 302 and repeats the processing.

On the other hand, if it is determined in Act 307 that the electric energy is 200 W, the CPU 45 proceeds to Act 309 and turns off a power supply for the excitation coils 21a and 21b. The CPU 45 returns to Act 302 and repeats the processing.

In the first embodiment, the CPU 45 sets timing for switching driving of the excitation coil 21a and the excitation coil 21b to timing when the voltage of the commercial AC power supply falls to 0 volt. By switching the driving at 0 volt, since sudden voltage and current are not applied to the energization coils, it is possible to eliminate a phenomenon that the heating roller 11 oscillates. It is also possible to reduce switching losses of the inverter circuit.

In the warm-up and ready states, since paper passing is not performed, heat is not deprived by a sheet. Therefore, temperature distribution in the rotation axis direction of the belt 14 does not change because of a size of the sheet. Heat is relatively often deprived from the entire rotation axis direction of the roller. Therefore, since a large temperature difference rarely occurs in the roller center and the roller ends of the belt 14, driving times set in the driving control tables corresponding to the warm-up and ready states are the four types explained above. Conversely, if the driving times are set with a larger ratio difference (e.g., 20 ms and 110 ms), it is likely that fluctuation in a temperature difference between the center and the sides increases.

This is because, since temperature detection time is long with respect to switching time for excitation coil driving, time lag occurs between temperature detection and driving, a temperature difference cannot be detected on a real time basis, and the detection delays a little. Therefore, the four kinds of driving times are at least set in the driving control tables to prevent a large change from occurring.

Even when there is a temperature difference, a high temperature side of the belt 14 is always heated as well. This is also because, if temperature response performance of the temperature detecting means (the thermopiles) and switching timing for the excitation coils shift, a mode for heating one of the center and the ends may be more often used to cause a temperature difference. As a roller heat capacity is smaller, it is more highly likely that temperature ripple increases. Therefore, the temperature distribution fluctuation in the roller rotation axis direction could be reduced by setting switching time for the excitation coils 21a and 21b as fine as possible and limiting time for driving only one of the excitation coils 21a and 21b.

An example of power control for the excitation coils 21a and 21b of the heating unit 21 in the paper passing state is explained. In the case of the paper passing state, as in the warm-up and ready states, the temperature of the belt 14 is detected by the thermopile 17a and the thermopile 17b. In the first embodiment, the detection of temperature is executed by the CPU 45 at every 200 (ms).

Electric power in the paper passing state is set to 1100 W at the maximum. Since various motors, other fans, and the like are more often used than at the warm-up time, electric power used in fixing is slightly reduced.

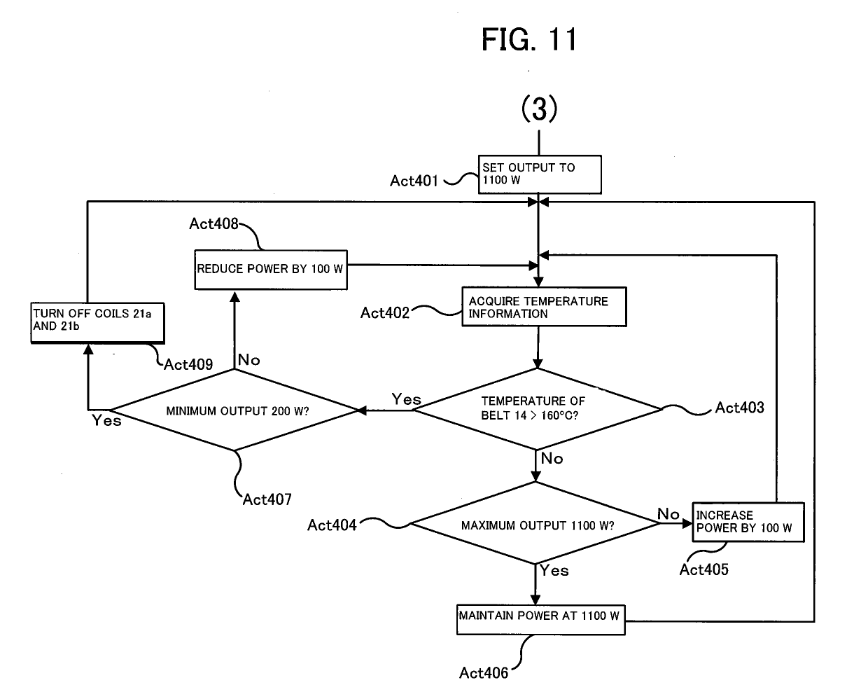

In the first embodiment, the control temperature is 160° C. When the temperatures both in the center and on the ends of the belt 14 exceed 160° C., electric power is gradually reduced to perform temperature control. When the temperature is equal to or lower than 160° C., electric power of the excitation coils 21a and 21b is changed according to driving control for the excitation coils 21a and 21b explained later (a flowchart of power control is shown in FIG. 11).

As shown in FIG. 11, in Act 401, first, the CPU 45 sets output power of the excitation coils 21a and 21b of the heating unit 2 to 1100 W. Subsequently, in Act 402, the CPU 45 acquires the temperatures in the center and at the ends of the belt 14 detected by the thermopiles 17a and 17b and determines whether the temperature of the belt 14 is higher than 160° C. (Act 403).

If it is determined that the temperature of the belt 14 is equal to or lower than 160° C., the CPU 45 proceeds to Act 404 and determines whether electric energy is the maximum output 1100 W.

If it is determined in Act 404 that the electric energy is not 1100 W, the CPU 45 proceeds to Act 405 and increases the electric energy by a predetermined value (e.g., 100 W). The CPU 45 returns to Act 402 and repeats the processing.

On the other hand, if it is determined in Act 404 that the electric energy is 1100 W, the CPU 45 proceeds to Act 406 and maintains the electric energy at 1100 W. The CPU 45 returns to Act 402 and repeats the processing.

If it is determined in Act 403 that the temperature of the belt 14 is higher than 160° C., the CPU 45 proceeds to Act 407 and determines whether electric energy is the minimum output 200 W.

If it is determined in Act 407 that the electric energy is not 200 W, the CPU 45 proceeds to Act 408 and reduces the electric energy by a predetermined value (e.g., 100 W). The CPU 45 returns to Act 402 and repeats the processing.

On the other hand, if it is determined in Act 407 that the electric energy is 200 W, the CPU 45 proceeds to Act 409 and turns off the power supply for the coils 21a and 21b. The CPU 45 returns to Act 402 and repeats the processing.

Driving control for the excitation coils 21a and 21b of the heating unit 21 in the paper passing state is explained in detail with reference to FIG. 12. In the first embodiment, Act 401 to Act 406 in the flowchart shown in FIG. 11 correspond to Act 501 to Act 503 in a flowchart shown in FIG. 12.

First, in Act 501, the temperature-information acquiring unit 51 acquires, as temperature information, the temperature of the belt 14 detected by the thermopiles 17a and 17b and sends the temperature information to the heating control unit 52. In Act 502, the heating control unit 52 checks, on the basis of the temperature information acquired by the temperature-information acquiring unit 51, whether the temperature of the belt 14 detected by the thermopiles 17a and 17b reaches the control temperature (160° C.).

If it is determined in Act 502 that the temperature of the belt 14 is equal to or lower than 160° C., first, in Act 503, the heating control unit 52 sets an output of the heating unit 21 to 1100 W. Subsequently, in Act 504, the heating control unit 52 executes, on the basis of the temperature information of the belt 14, comparison of the temperatures in the center and at the ends of the belt 14 detected by the thermopiles 17a and 17b. The heating control unit 52 selects, on the basis of a result of the temperature comparison, driving time for each of the temperature differences set in the driving control table (FIG. 7) corresponding to the paper passing state and performs control of the excitation coils of the heating unit 21. In the driving control table corresponding to the paper passing state, when the temperature difference between the center and the ends is larger than 10° C., driving time for the excitation coils that heats an area having lower temperature is set longer than the driving time in the driving control table corresponding to the warm-up and ready states.

Specifically, processing can be performed as explained below on the basis of the driving control table shown in FIG. 7.

First, in Act 504, the heating control unit 52 determines whether a temperature difference between the center and the ends of the belt 14 is equal to or smaller than 5° C. If it is determined that the temperature difference is equal to or smaller than 5° C., the heating control unit 52 drives each of the excitation coils 21a and 21b of the heating unit 21 for 20 ms (Act 505). Subsequently, the heating control unit 52 returns to Act 501 and repeats the processing until it is determined in Act 502 that the temperature of the belt 14 reaches 160° C.

If it is determined in Act 504 that the temperature difference between the center and the ends of the belt 14 is larger than 5° C., the heating control unit 52 proceeds to Act 506 and determines whether the temperature difference between the center and the ends of the belt 14 is 5 to 10° C. If it is determined that the temperature difference is 5 to 10° C., the heating control unit 52 drives, for 40 ms, the excitation coil(s) that heats (heat) a side determined as having lower temperature among the excitation coils 21a and 21b of the heating unit 21. The heating control unit 52 drives, for 20 ms, the excitation coil(s) that heats (heat) a side determined as having higher temperature (Act 507). The heating control unit 52 returns to Act 501 and repeats the processing until it is determined in Act 502 that the temperature of the belt 14 reaches 160° C.

If it is determined in Act 506 that the temperature difference between the center and the ends of the belt 14 is larger than 10° C., the heating control unit 52 proceeds to Act 508 and determines whether the temperature difference between the center and the ends of the belt 14 is 10 to 15° C. If it is determined that the temperature difference is 10 to 15° C., the heating control unit 52 drives, for 80 ms, the excitation coil(s) that heats (heat) a side determined as having lower temperature among the excitation coils 21a and 21b of the heating unit 21 (Act 509). Further, the heating control unit 52 drives, for 20 ms, the excitation coil(s) that heats (heat) a side determined as having higher temperature (Act 509). Subsequently, the temperature-information acquiring unit 51 acquires temperature information of the belt 14 (Act 510). The heating control unit 52 determines, on the basis of the acquired temperature information, whether a temperature difference between the center and the ends is equal to or smaller than 5° C. (Act 511). If it is determined that the temperature difference between the center and the ends is larger than 5° C., the heating control unit 52 returns to Act 509 and repeats the processing. On the other hand, if it is determined that the temperature difference between the center and the ends is equal to or smaller than 5° C., the heating control unit 52 returns to Act 501 and repeats the processing until it is determined in Act 502 that the temperature of the belt 14 reaches 160° C.

If it is determined in Act 512 that the temperature difference between the center and the ends of the belt 14 is larger than 15° C., the heating control unit 52 proceeds to Act 512 and determines whether the temperature difference between the center and the ends of the belt 14 is 15 to 20° C. If it is determined that the temperature difference is 15 to 20° C., the heating control unit 52 drives, for 120 ms, the excitation coil(s) that heats (heat) a side determined as having lower temperature among the excitation coils 21a and 21b of the heating unit 21 (Act 513). Further, the heating control unit 52 drives, for 20 ms, the excitation coil(s) that heats (heat) a side determined as having higher temperature (Act 513). Subsequently, the temperature-information acquiring unit 51 acquires temperature information of the belt 14 (Act 514). The heating control unit 52 determines, on the basis of the acquired information, whether a temperature difference between the center and the ends is equal to or smaller than 5° C. (Act 515). If it is determined that the temperature difference between the center and the ends is larger than 5° C., the heating control unit 52 returns to Act 513 and repeats the processing. On the other hand, if it is determined that the temperature difference between the center and the ends is equal to or smaller than 5° C., the heating control unit 52 returns to Act 501 and repeats the processing until it is determined in Act 502 that the temperature of the belt 14 reaches 160° C.

If it is determined in Act 512 that the temperature difference between the center and the ends of the belt 14 is larger than 20° C., the heating control unit 52 drives, for 160 ms, the excitation coil(s) that heats (heat) a side determined as having lower temperature among the excitation coils 21a and 21b of the heating unit 21 (Act 516). Further, the heating control unit 52 drives, for 20 ms, the excitation coil(s) that heats (heat) a side determined as having higher temperature (Act 516). Subsequently, the temperature-information acquiring unit 51 acquires temperature information of the belt 14 (Act 517). The heating control unit 52 determines, on the basis of the acquired temperature information, whether a temperature difference between the center and the ends is equal to or smaller than 5° C. (Act 518). If it is determined that the temperature difference between the center and the ends is larger than 5° C., the heating control unit 52 returns to Act 516 and repeats the processing. On the other hand, if it is determined that the temperature difference between the center and the ends is equal to or smaller than 5° C., the heating control unit 52 returns to Act 501 and repeats the processing until it is determined in Act 502 that the temperature of the belt 14 reaches 160° C.

As a result of performing the processing explained above, even when temperature distribution in the rotation axis direction of the belt 14 is more likely to be non-uniform than in the warm-up and ready states, it is possible to keep the temperature distribution substantially constant.

As explained above, in the first embodiment, driving time for heater(s) (the excitation coil(s)) that heats (heat) the second area having temperature lower than that of the first area among the plural areas of the belt 14 is set longer than driving time for heater(s) that heats (heat) the first area. Consequently, it is possible to keep temperature distribution in the rotation axis direction on the belt substantially constant more easily than in the past.

Driving time for the heaters is selected according to an operation state of the image forming apparatus as well as a temperature difference of temperature distribution in the rotation axis direction on the belt. Consequently, it is possible to control temperature distribution in the rotation axis direction on the belt more substantially uniform.

Even if time lag occurs between thermal response time of the temperature detecting means (the thermopiles) and temperature rise of the belt, since driving times of the heaters that heat the first area and the second area are switched at timing finer than timing (200 ms) for temperature detection to perform temperature control, it is possible to perform control such that a large temperature difference less easily occurs.

### Second Embodiment

In a second embodiment of the present invention, the heating control unit 52 is configured to perform driving control for the excitation coils 21a and 21b corresponding to reduced sheet conveying speed in addition to the driving control for the excitation coils 21a and 21b illustrated in the explanation of the first embodiment.

In the second embodiment, the image forming apparatus 1 is configured to change conveying speed according to a type of a sheet to be passed. For example, when thick paper or glossy paper is passed, conveying speed is set smaller (e.g., 135 mm/s) than that in a paper passing state of a normal sheet (e.g., 270 mm/s). When the conveying speed is changed in this way, time for the belt 14 coming closer to the excitation coils also changes. In other words, when the conveying speed decreases, a heat quantity that the belt 14 receives from the excitation coils increases.

Therefore, for example, when the thick paper or the glossy paper is passed, if driving control for the excitation coils is performed on the basis of a driving control table same as that in the paper passing state of the normal sheet, a temperature difference among plural areas in the rotation axis direction of the belt 14 may increase. Therefore, when the conveying speed is set low, time for driving the excitation coils that heat an area having lower temperature is set shorter than that in the paper passing state of the normal sheet.

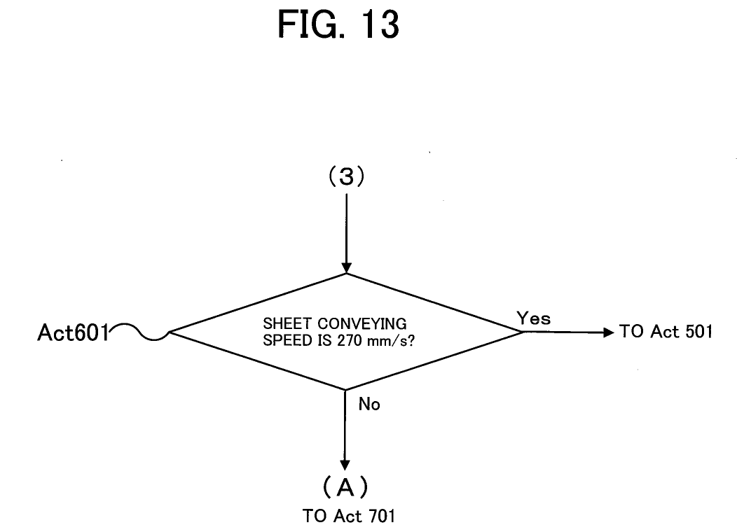

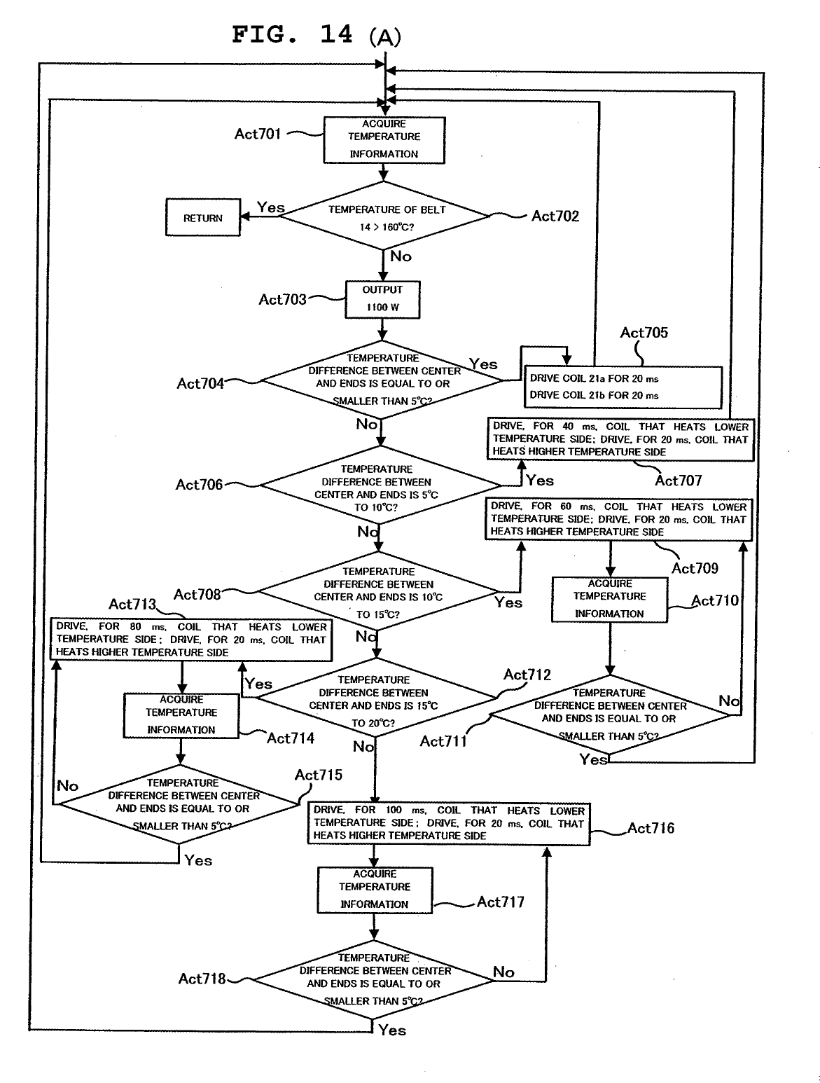

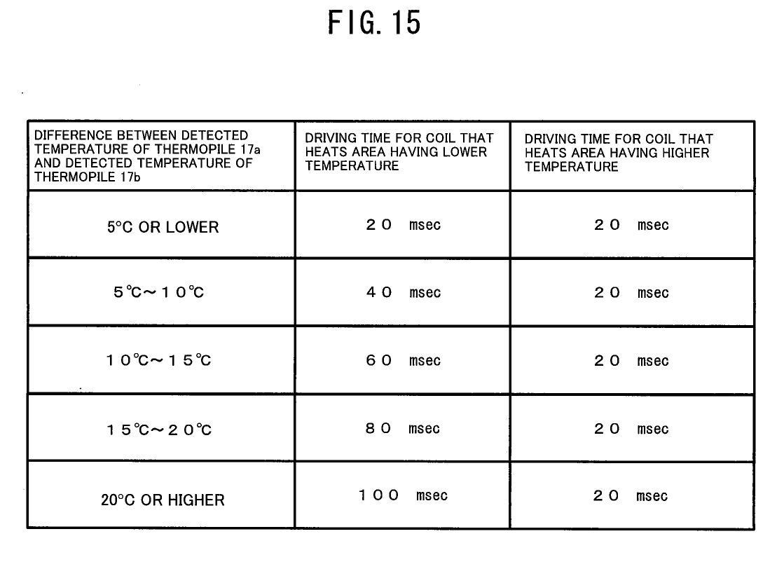

A flowchart indicating a flow of processing according to the second embodiment is explained with reference to FIGS. 13 and 14. As a driving control table at conveying speed set to 270 mm/s, the driving control table shown in FIG. 7 is used. On the other hand, as a driving control table at conveying speed set to 135 mm/s, the driving control table shown in FIG. 15 is used.

First, the heating control unit 52 determines, according to an operation state of the image forming apparatus 1, based on which of the driving control tables stored in the memory 54 driving control for the excitation coils 21a and 21b of the heating unit 21 should be performed. In the flowchart, acts for determining which of the warm-up state, the ready state, and the paper passing state the image forming apparatus 1 is in are the same as those in the flowchart shown in FIG. 8 in the first embodiment. Therefore, explanation of the acts is omitted.

In the second embodiment, if it is determined that the operation state of the image forming apparatus 1 is the paper passing state, the heating control unit 52 proceeds to (3) in FIG. 8. Further, as shown in FIG. 13, in Act 601, the heating control unit 52 determines whether sheet conveying speed is 270 mm/s.

If it is determined in Act 601 that the sheet conveying speed is 270 mm/s, the heating control unit 52 proceeds to Act 501. Driving control corresponding to a driving control table at conveying speed set to 270 mm/s is performed. The driving control table is the driving control table shown in FIG. 7 and is the same as that in the paper passing state in the first embodiment.

Driving control for the excitation coils at conveying seed 270 mm/s is the same as the driving control in the paper passing state in the first embodiment. Therefore, explanation of the driving control is omitted.

On the other hand, if it is determined in Act 601 that the conveying speed is not 270 mm/s, the heating control unit 52 proceeds to (A) in FIG. 13 and determines that the image forming apparatus 1 performs paper passing processing at, for example, 135 mm/s, which is speed for paper passing of the thick paper and the glossy paper. The heating control unit 52 proceeds to Act 701 as shown in FIG. 14 and performs driving control for the excitation coils 21a and 21b of the heating unit 21 using the driving control table corresponding to the paper passing processing at 135 mm/s.

Driving control for the excitation coils 21a and 21b is specifically explained below. As shown in FIG. 14, in Act 701, the temperature-information acquiring unit 51 acquires, as temperature information, the temperature of the belt 14 detected by the thermopiles 17a and 17b and sends the temperature information to the heating control unit 52. In Act 702, the heating control unit 52 checks, on the basis of the temperature information acquired by the temperature-information acquiring unit 51, whether the temperature of the belt 14 detected by the thermopiles 17a and 17b reaches control temperature (in the second embodiment, 160° C.)

If it is determined in Act 702 that the temperature of the belt 14 is equal to or lower than 160° C., first, in Act 703, the heating control unit 52 sets an output of the excitation coils of the heating unit 21 to 1100 W. Subsequently, in Act 704, the heating control unit 52 executes, on the basis of the temperature information of the belt 14, comparison of temperatures in the center and at the ends of the belt 14 detected by the thermopiles 17a and 17b. The heating control unit 52 selects, on the basis of a result of the temperature comparison, driving time for each of temperature differences set in the driving control table corresponding to a paper passing state at conveying speed set to 135 mm/s and performs driving control for the excitation coils of the heating unit 21.

Specifically, processing can be performed as explained below on the basis of a driving control table shown in FIG. 15.

First, in Act 704, the heating control unit 52 determines whether a temperature difference between the center and the ends of the belt 14 is equal to or smaller than 5° C. If it is determined that the temperature difference is equal to or smaller than 5° C., the heating control unit 52 drives each of the excitation coils 21a and 21b of the heating unit 21 for 20 ms (Act 705). The heating control unit 52 returns to Act 701 and repeats the processing until it is determined in Act 702 that the temperature of the belt 14 reaches 160° C.

If it is determined in Act 704 that the temperature difference between the center and the ends of the belt 14 is larger than 5° C., the heating control unit 52 proceeds to Act 706 and determines whether the temperature difference between the center and the ends of the belt 14 is 5 to 10° C. If it is determined that the temperature difference is 5 to 10° C., the heating control unit 52 drives, for 40 ms, the excitation coil(s) that heats (heat) a side determined as having lower temperature among the excitation coils 21a and 21b of the heating unit 21. The heating control unit 52 drives, for 20 ms, the excitation coil(s) that heats (heat) a side determined as having higher temperature (Act 707). The heating control unit 52 returns to Act 701 and repeats the processing until it is determined in Act 702 that the temperature of the belt 14 reaches 160° C.

If it is determined in Act 706 that the temperature difference between the center and the ends of the belt 14 is larger than 10° C., the heating control unit 52 proceeds to Act 708 and determines whether the temperature difference between the center and the ends of the belt 14 is 10 to 15° C. If it is determined that the temperature difference is 10 to 15° C., the heating control unit 52 drives, for 60 ms, the excitation coil(s) that heats (heat) a side determined as having lower temperature among the excitation coils 21a and 21b of the heating unit 21 (Act 709). Further, the heating control unit 52 drives, for 20 ms, the excitation coil(s) that heats (heat) a side determined as having high temperature (Act 709). Subsequently, the temperature-information acquiring unit 51 acquires temperature information of the belt 14 (Act 710). The heating control unit 52 determines, on the basis of the acquired temperature information, whether a temperature difference between the center and the ends is equal to or smaller than 5° C. (Act 711). If it is determined that the temperature difference between the center and the ends is larger than 5° C., the heating control unit 52 returns to Act 709 and repeats the processing. On the other hand, if it is determined that the temperature difference between the center and the ends is equal to or smaller than 5° C., the heating control unit 52 returns to Act 701 and repeats the processing until it is determined in Act 702 that the temperature of the belt 14 reaches 160° C.

If it is determined in Act 708 that the temperature difference between the center and the ends of the belt 14 is larger than 15° C., the heating control unit 52 proceeds to S712 and determines whether the temperature difference between the center and the ends of the belt 14 is 15 to 20° C. If it is determined that the temperature difference is 15 to 20° C., the heating control unit 52 drives, for 80 ms, the excitation coil(s) that heats (heat) a side determined as having lower temperature among the excitation coils 21a and 21b of the heating unit 21 (Act 713). Further, the heating control unit 52 drives, for 20 ms, the excitation coil(s) that heats (heat) a side determine as having high temperature (Act 713). Subsequently, the temperature-information acquiring unit 51 acquires temperature information of the belt 14 (Act 714). The heating control unit 52 determines, on the basis of the acquired temperature information, whether a temperature difference between the center and the ends is equal to or smaller than 5° C. (Act 715). If it is determined that the temperature difference between the center and the ends is larger than 5° C., the heating control unit 52 returns to Act 713 and repeats the processing. On the other hand, if it is determined that the temperature difference between the center and the ends is equal to or smaller than 5° C., the heating control unit 52 returns to Act 701 and repeats the processing until it is determined in Act 702 that the temperature of the belt 14 reaches 160° C.

If it is determined in Act 712 that the temperature difference between the center and the ends of the belt 14 is larger than 20° C., the heating control unit 52 drives, for 100 ms, the excitation coil(s) that heats (heat) a side determined as having lower temperature among the excitation coils 21a and 21b of the heating unit 21 (Act 716). Further, the heating control unit 52 drives, for 20 ms, the excitation coil(s) that heats (heat) a side determined as having higher temperature (Act 716). Subsequently, the temperature-information acquiring unit 51 acquires temperature information of the belt 14 (Act 717). The heating control unit 52 determines, on the basis of the acquired temperature information, whether a temperature difference between the center and the ends is equal to or smaller than 5° C. (Act 718). If it is determined that the temperature difference between the center and the ends is larger than 5° C., the heating control unit 52 returns to Act 716 and repeats the processing. On the other hand, if it is determined that the temperature difference between the center and the end is equal to or smaller than 5° C., the heating control unit 52 returns to Act 701 and repeats the processing until it is determined in Act 702 that the temperature of the belt 14 reaches 160° C.

As a result of performing the processing explained above, even when the image forming apparatus has an operation mode with reduced conveying speed, it is possible to keep temperature distribution in the rotation axis direction on the belt 14 substantially constant.

### Third Embodiment

In a third embodiment of the present invention, the heating control unit 52 is configured to perform driving control for the excitation coils 21a and 21b corresponding to continuous paper passing of small-size sheets in addition to the driving control for the excitation coils 21a and 21b explained in the first embodiment.

When small-size sheets such as A4R sheets are continuously passed, a heat quantity to be deprived is different in an area in contact with the small-size sheets in the rotation axis direction of the belt 14, for example, the center, and an area not in contact with the small-size sheets, for example, the ends. Specifically, whereas a consumed heat quantity is large in the center, almost no heat quantity is consumed at the ends. Therefore, when the small-size sheets are continuously passed, a difference in temperature distribution in the rotation axis direction of the belt 14 tends to be larger than that in paper passing of normal sheets. Therefore, in an operation state in which the small-size sheets are continuously passed, driving control for the excitation coils is performed on the basis of the driving control table corresponding to the operation state.

In the third embodiment, a sheet having an area of contact with the belt 14 in the rotation axis direction of the belt 14 larger than that of the A4R sheet is referred to as normal sheet. A sheet having an area of contact with the belt 14 equal to or smaller than that of the A4R sheet is referred to as small-size sheet.

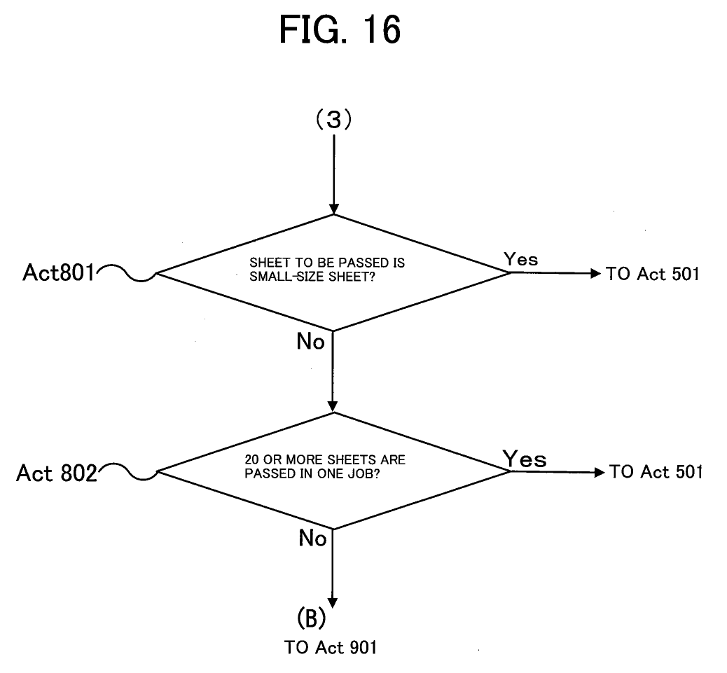

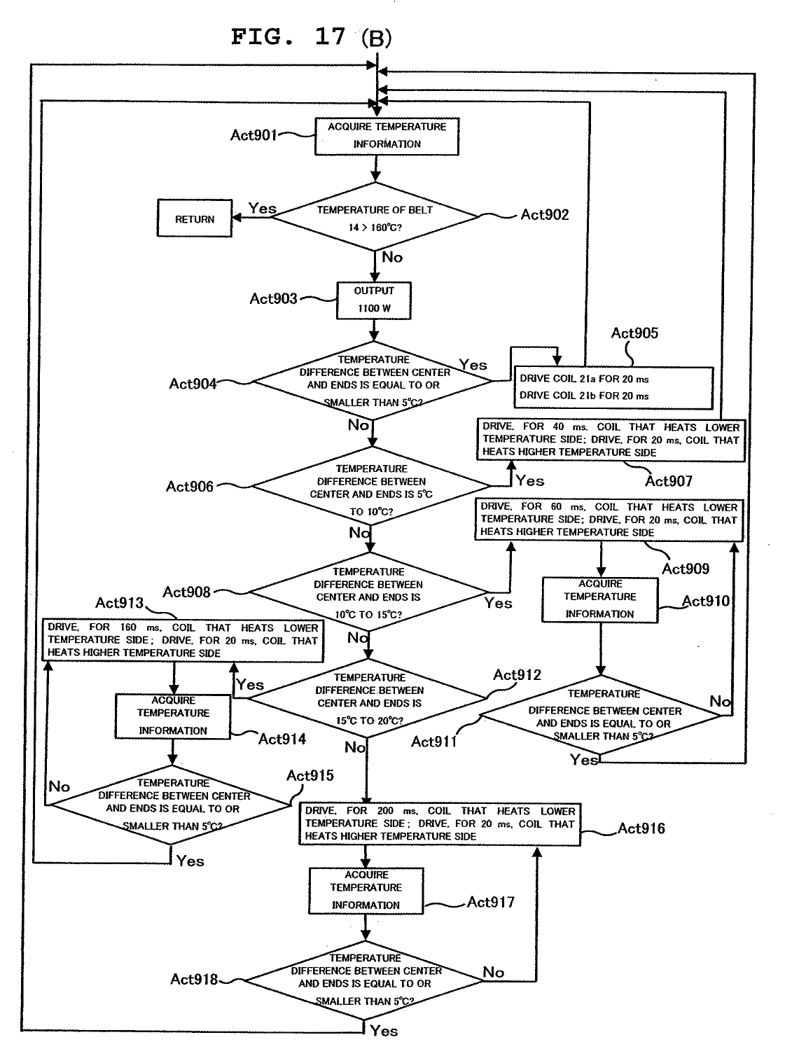

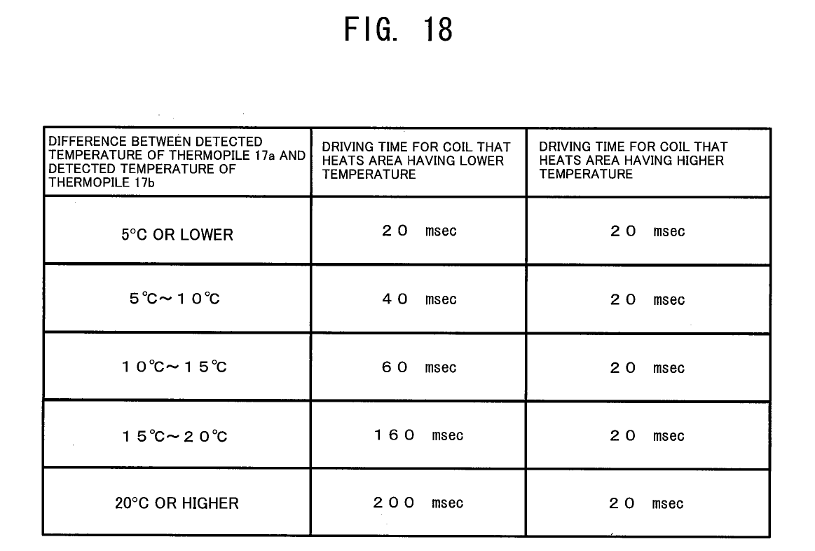

A flowchart indicating a flow of processing according to the third embodiment is explained with reference to FIGS. 16 and 17. When paper larger than the small-size sheet is passed or when the number of small-size sheets to be passed is smaller than a predetermined number, for example, smaller than twenty, the driving control table shown in FIG. 7 is used. When the predetermined number of small-size sheets are continuously passed, for example, when twenty or more sheets having a size equal to or smaller than A4-R are continuously passed, a driving control table shown in FIG. 18 is used. It goes without saying that twenty is only an example and is a value that could fluctuate according to fixing temperature, a type of a sheet, or the like.

First, the heating control unit 52 determines, according to an operation state of the image forming apparatus 1, based on which of the driving control tables stored in the memory 54 driving control for the excitation coils 21a and 21b of the heating unit 21 should be performed. In the flowchart, acts for determining which of the warm-up state, the ready state, and the paper passing state the image forming apparatus 1 is in are the same as those in the flowchart shown in FIG. 8 in the first embodiment. Therefore, explanation of the acts is omitted.

In FIG. 8, if it is determined that the operation state of the image forming apparatus 1 is the paper passing state, the heating control unit 52 proceeds to (3). Further, as shown in FIG. 16, in Act 801, the heating control unit 52 determines whether a sheet to be passed is the small-size sheet.

If it is determined in Act 801 that the sheet to be passed is not the small-size sheet, the heating control unit 52 proceeds to Act 501 and performs driving control corresponding to a driving control table in a paper passing state of the normal sheet.

If it is determined in Act 801 that the sheet to be passed is the small-size sheet, the heating control unit 52 proceeds to Act 802 and determines whether the number of sheets to be passed in one job is equal to or larger than twenty. If it is determined that the number of sheets to be passed is smaller than twenty, the heating control unit 52 proceeds to Act 501 and performs driving control corresponding to the driving control table in the paper passing state of the normal sheet.

Driving control for the excitation coils of the heating unit 21 corresponding to the driving control table in the paper passing state of the normal sheet is the same as that in the first embodiment. Therefore, explanation of the driving control is omitted.

On the other hand, if it is determined in Act 802 that the number of small-size sheets to be passed in one job is equal to or larger than twenty, the heating control unit 52 proceeds to (B). Further, as shown in FIG. 17, the heating control unit 52 proceeds to Act 901 and performs, on the basis of a flowchart shown in FIG. 17, driving control for the excitation coils of the heating unit 21 using the driving control table shown in FIG. 18 corresponding to the paper passing of twenty or more small-size sheets.

First, in Act 901, the temperature-information acquiring unit 51 acquires, as temperature information, the temperature of the belt 14 detected by the thermopiles 17a and 17b and sends the temperature information to the heating control unit 52. In Act 902, the heating control unit 52 determines, on the basis of the temperature information acquired from the temperature-information acquiring unit 51, the temperature of the belt 14 detected by the thermopiles 17a and 17b reaches control temperature (in the third embodiment, 160° C.).

If it is determined in Act 902 that the temperature of the belt 14 is equal to or lower than 160° C., first, in Act 903, the heating control unit 52 sets an output of the excitation coils of the heating unit 21 to 1100 W. Subsequently, in Act 904, the heating control unit 52 executes, on the basis of the temperature information of the belt 14, comparison of temperatures in the center and at the ends of the belt 14 detected by the thermopiles 17a and 17b. The heating control unit 52 selects, on the basis of a result of the temperature comparison, driving time for each of the temperature differences set in the driving control table for continuous paper passing of small-size sheets and performs driving control for the excitation coils 21a and 21b of the heating unit 21.

Specifically, processing can be performed as explained below on the basis of the driving control table shown in FIG. 18.

First, in Act 904, the heating control unit 52 determines whether a temperature difference between the center and the ends of the belt 14 is equal to or smaller than 5° C. If it is determined that the temperature difference is equal to or smaller than 5° C., the heating control unit 52 drives each of the excitation coils 21a and 21b of the heating unit 21 for 20 ms (Act 905). Subsequently, the heating control unit 52 returns to Act 901 and repeats the processing until it is determined in Act 902 that the temperature of the belt 14 reaches 160° C.

If it is determined in Act 904 that the temperature difference between the center and the ends of the belt 14 is larger than 5° C., the heating control unit 52 proceeds to Act 906 and determines whether the temperature difference between the center and the ends of the belt 14 is 5 to 10° C. If it is determined that the temperature difference is 5 to 10° C., the heating control unit 52 drives, for 40 ms, the excitation coil(s) that heats (heat) a side determined as having lower temperature among the excitation coils 21a and 21b of the heating unit 21. The heating control unit 52 drives, for 20 ms, the excitation coil(s) that heats (heat) a side determined as having higher temperature (Act 907). The heating control unit 52 returns to Act 901 and repeats the processing until it is determined in Act 902 that the temperature of the belt 14 reaches 160° C.

If it is determined in Act 906 that the temperature difference between the center and the ends of the belt 14 is larger than 10° C., the heating control unit 52 proceeds to Act 908 and determines whether the temperature difference between the center and the ends of the belt 14 is 10 to 15° C. If it is determined that the temperature difference is 10 to 15° C., the heating control unit 52 drives, for 60 ms, the excitation coils that heat the side determined as having lower temperature among the excitation coils 21a and 21b of the heating unit 21 (Act 909). Further, the heating control unit 52 drives, for 20 ms, the excitation coil that heats the side determined as having higher temperature (Act 909). Subsequently, the temperature-information acquiring unit 51 acquires temperature information of the belt 14 (Act 910). The heating control unit 52 determines, on the basis of the acquired temperature information, whether a temperature difference between the center and the ends is equal to or smaller than 5° C. (Act 911). If it is determined that the temperature difference between the center and the ends is larger than 5° C., the heating control unit 52 returns to Act 909 and repeats the processing. On the other hand, if it is determined that the temperature difference between the center and the ends is equal to or smaller than 5° C., the heating control unit 52 returns to Act 901 and repeats the processing until it is determined in Act 902 that the temperature of the belt 14 reaches 160° C.

If it is determined in Act 908 that the temperature difference between the center and the ends of the belt 14 is larger than 15° C., the heating control unit 52 proceeds to Act 912 and determines whether the temperature difference between the center and the ends of the belt 14 is 15 to 20° C. If it is determined that the temperature difference between the center and the ends is 15 to 20° C., the heating control unit 52 drives, for 160 ms, the excitation coils that heat the side determined as having lower temperature among the excitation coils 21a and 21b of the heating unit 21 (Act 913). Further, the heating control unit 52 drives, for 20 ms, the excitation coil that heats the side determined as having higher temperature (Act 913). Subsequently, the temperature-information acquiring unit 51 acquires temperature information of the belt 14 (Act 914). The heating control unit 52 determines, on the basis of the acquired temperature information, whether a temperature difference between the center and the ends is equal to or smaller than 5° C. (Act 915). If it is determined that the temperature difference between the center and the ends of the belt 14 is larger than 5° C., the heating control unit 52 returns to Act 913 and repeats the processing. On the other hand, if it is determined that the temperature difference between the center and the ends is equal to or smaller than 5° C., the heating control unit 52 returns to Act 901 and repeats the processing until it is determined in Act 902 that the temperature of the belt 14 reaches 160° C.

If it is determined in Act 912 that the temperature difference between the center and the ends of the belt 14 is larger than 20° C., the heating control unit 52 drives, for 200 ms, the excitation coil(s) that heats (heat) a side determined as having lower temperature among the excitation coils 21a and 21b of the heating unit 21 (Act 916). Further, the heating control unit 52 drives, for 20 ms, the excitation coil(s) that heats (heat) a side determined as having higher temperature (Act 916). Subsequently, the temperature-information acquiring unit 51 acquires temperature information of the belt 14 (Act 917). The heating control unit 52 determines, on the basis of the acquired temperature information, whether a temperature difference between the center and the ends is equal to or smaller than 5° C. (Act 918). If it is determined that the temperature difference between the center and the ends is larger than 5° C., the heating control unit 52 returns to Act 916 and repeats the processing. On the other hand, if it is determined that the temperature difference between the center and the end is equal to or smaller than 5° C., the heating control unit 52 returns to Act 901 and repeats the processing until it is determined in Act 902 that the temperature of the belt 14 reaches 160° C.

As a result of performing the processing explained above, even when the image forming apparatus continuously performs paper passing of a predetermined number or more of small-size sheets, it is possible to keep temperature distribution in the rotation axis direction on the belt 14 substantially constant.

### Fourth Embodiment

In a fourth embodiment of the present invention, the heating control unit 52 is configured to perform driving control for the excitation coils 21a and 21b corresponding to a temperature state in the image forming apparatus 1 in the paper passing state in addition to the driving control for the excitation coils 21a and 21b explained in the first embodiment.

More specifically, a degree of temperature rise of the belt 14 tends to be different according to a difference in temperature in the inside of the image forming apparatus 1. When the temperature in the inside of the image forming apparatus 1 is lower than usual, the temperature less easily rises even if the belt 14 is heated in the same driving time. Therefore, the heating control unit 52 performs driving control for the excitation coils 21a and 21b of the heating unit 21 using driving control tables corresponding to temperatures in the inside of the image forming apparatus, i.e., temperature equal to or lower than predetermined temperature, for example, equal to or lower than 10° C. and temperature higher than the predetermined temperature, for example, higher than 10° C.

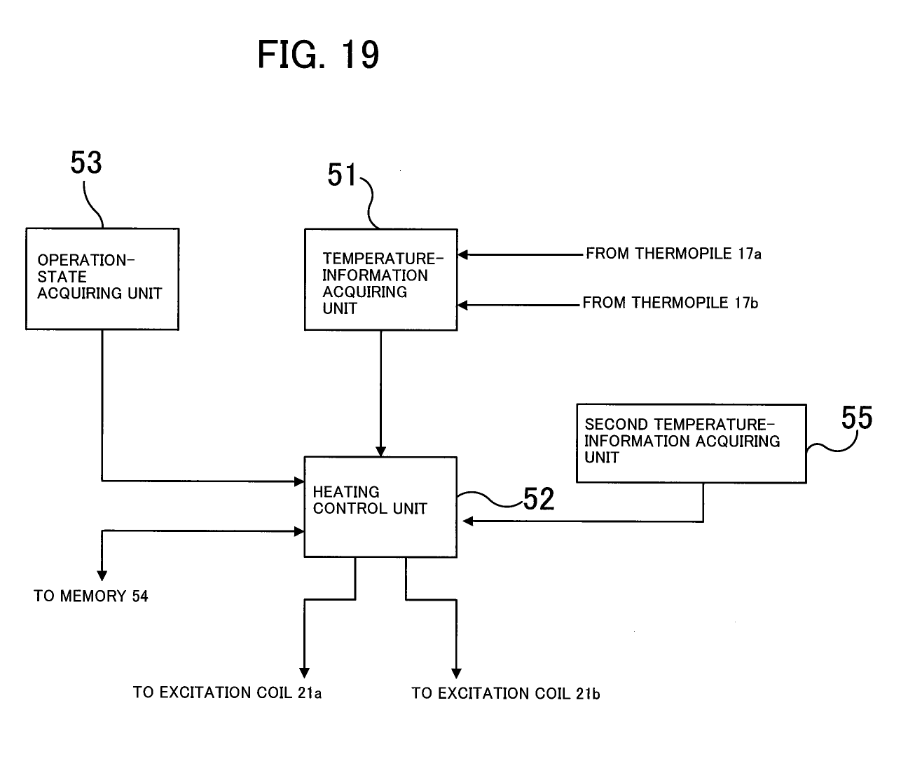

First, functional blocks according to the fourth embodiment are explained with reference to FIG. 19. Functions of the respective blocks shown in FIG. 19 are realized by causing the CPU 45 to execute, for example, various computer programs stored in the memory 54.

As shown in FIG. 19, the driving control for the excitation coils of the fixing device according to the fourth embodiment is performed by the temperature-information acquiring unit 51, the heating control unit 52, and a second temperature-information acquiring unit 55.

The functional blocks other than the second temperature-information acquiring unit 55 and the heating control unit 52 are the same as those in the first embodiment. Therefore, explanation of the functional blocks is omitted.

The second temperature-information acquiring unit 55 acquires, as temperature information in the inside of the image forming apparatus 1, temperature detected by a temperature sensor (not shown) arranged in the inside of the image forming apparatus 1 and sends the temperature information to the heating control unit 52. The temperature sensor can be arranged near, for example, photoconductive members, transfer rollers, or the like in the image forming apparatus 1. In this case, the temperature sensor detects temperature around a process unit.

The heating control unit 52 controls, on the basis of temperature information of the belt 14 acquired from the temperature-information acquiring unit 51 and temperature information in the inside of the image forming apparatus 1 acquired by the second temperature-information acquiring unit 55, driving time for the excitation coils 21a and 21b of the heating unit 21 to thereby control temperature in the rotation axis direction of the belt 14. In the fourth embodiment, as in the other embodiments, the excitation coils 21a and 21b are alternately driven.

An example of the temperature control by the heating control unit 52 is more specifically explained. First, the heating control unit 52 determines an operation state of the image forming apparatus 1 on the basis of information concerning an operation state of the image forming apparatus 1 acquired from the operation-information acquiring unit 53. If it is determined that the operation state of the image forming apparatus is the warm-up and ready states, the heating control unit 52 performs driving control for the excitation coils according to a method same as that in the first embodiment. On the other hand, if it is determined that the operation state of the image forming apparatus 1 is the paper passing state, the heating control unit 52 determines, on the basis of information concerning temperature in the inside of the image forming apparatus 1 acquired by the second temperature-information acquiring unit 55, whether temperature in the inside of the heating control unit 52 is equal to or lower than a predetermined value. Subsequently, the heating control unit 52 calculates, on the basis of temperature information acquired from the temperature-information acquiring unit 51, a temperature difference between the first area (one of the center and the ends) and the second area (the other of the center and the ends) of the belt 14. Referring to the driving control tables stored in the memory 54, the heating control unit 52 selects, as driving time for the respective excitation coils that heat the first and second areas, driving time associated with the temperature difference on the belt 14 and the temperature in the inside of the image forming apparatus 1 among plural kinds of driving times set as driving times of the respective excitation coils that heat the first and second area.

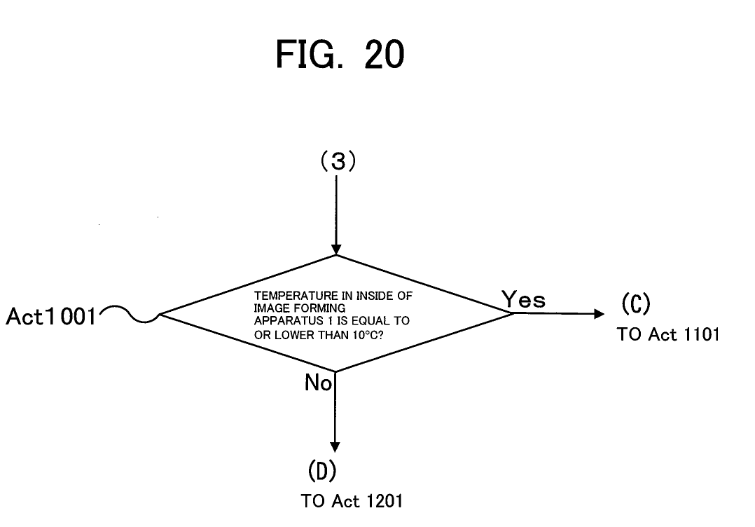

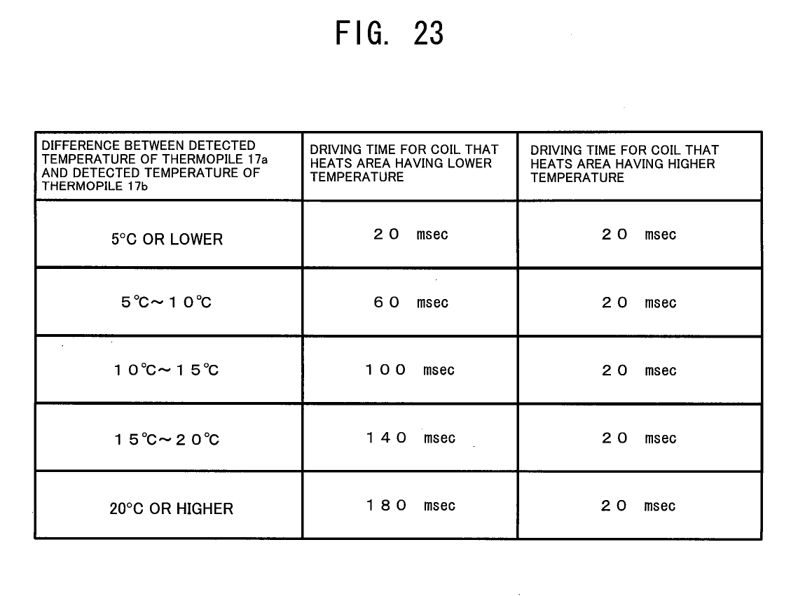

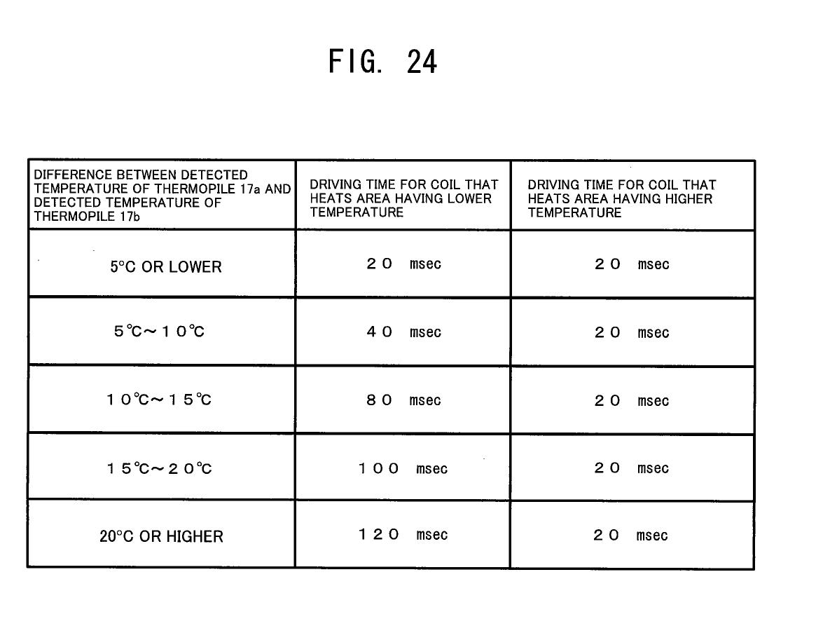

A flowchart indicating a flow of processing according to the fourth embodiment is explained with reference to FIGS. 20, 21, and 22. A driving control table at internal temperature equal to or lower than 10° C. of the image forming apparatus 1 is shown in FIG. 23. A driving control table at internal temperature higher than 10° C. is shown in FIG. 24.

First, the heating control unit 52 determines, according to an operation state of the image forming apparatus 1, based on which of the driving control tables stored in the memory 54 driving control for the excitation coils 21a and 21b of the heating unit 21 should be performed. In the flowchart, acts for determining which of the warm-up state, the ready state, and the paper passing state the image forming apparatus 1 is in are the same as those in the flowchart shown in FIG. 8 in the first embodiment. Therefore, explanation of the acts is omitted.

In FIG. 8, in the fourth embodiment, if it is determined that the operation state of the image forming apparatus 1 is the paper passing state, the heating control unit 52 proceeds to (3) in FIG. 8. Further, as shown in FIG. 20, in Act 1001, the heating control unit 52 determines whether internal temperature of the image forming apparatus 1 is equal to or lower than 10° C.

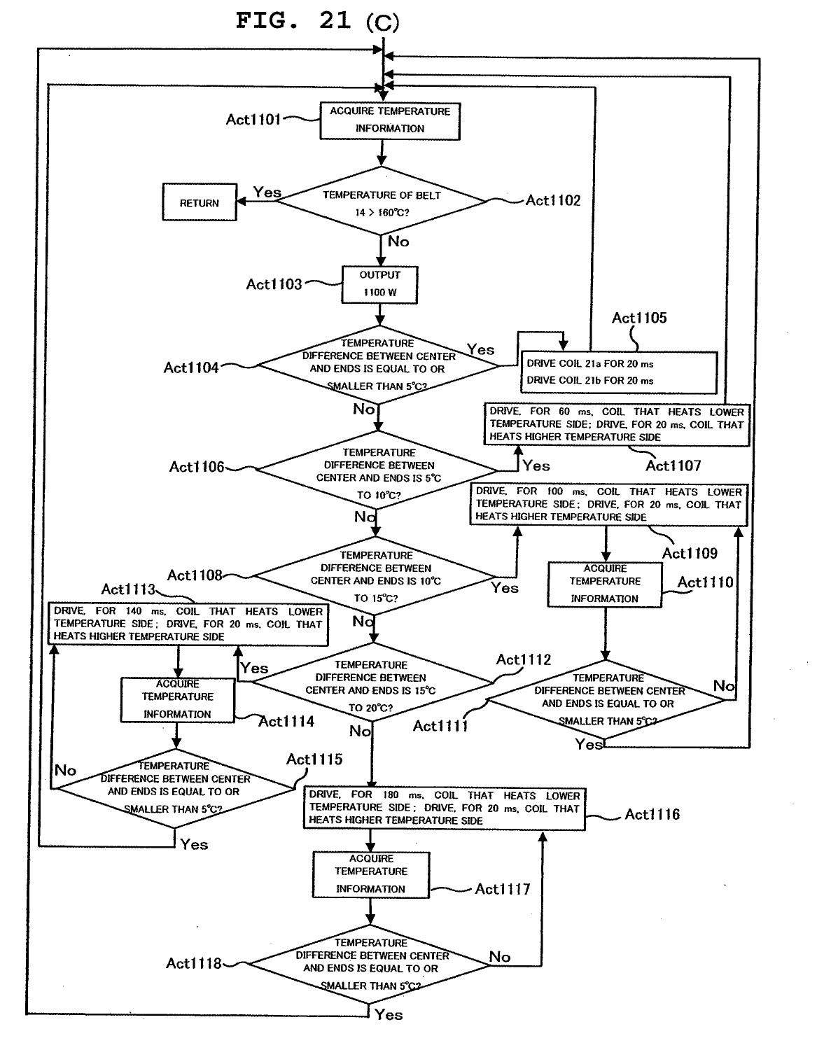

If it is determined in Act 1001 that the internal temperature of the image forming apparatus 1 is equal to or lower than 10° C., the heating control unit 52 proceeds to (C), further proceeds to Act 1101 as shown in FIG. 21, and performs driving control corresponding to a driving control table at internal temperature equal to or lower than 10° C. of the image forming apparatus 1. The driving control table is the driving control table shown in FIG. 23.

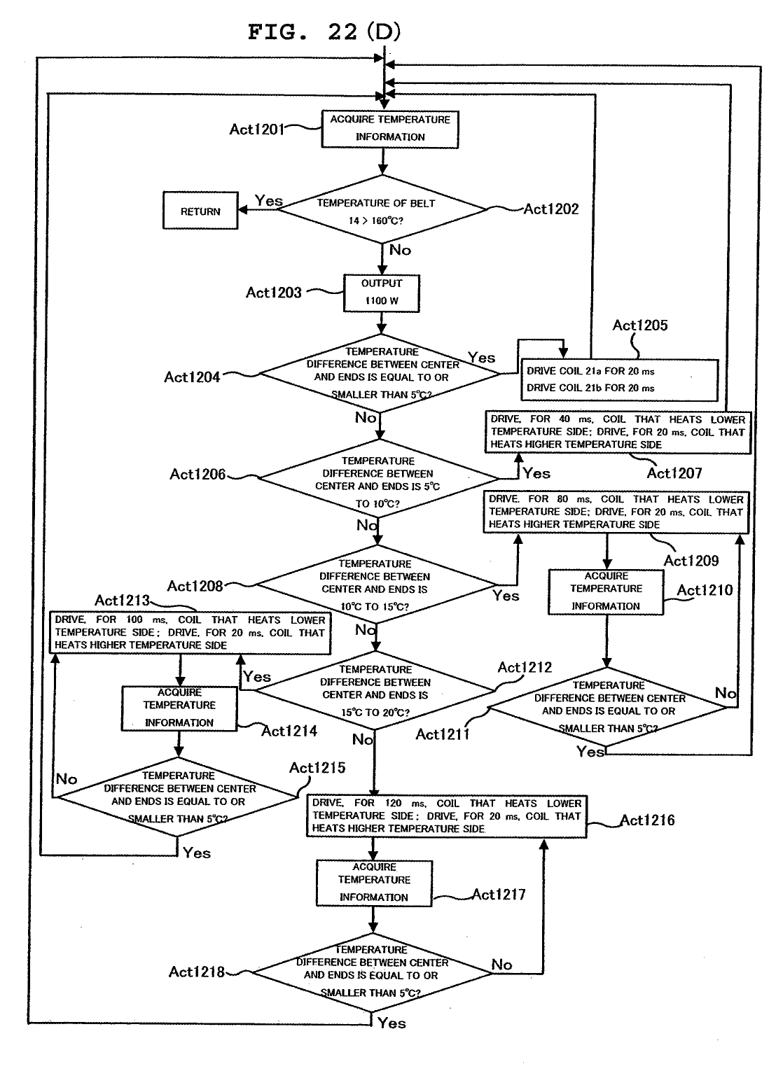

On the other hand, if it is determined in Act 1001 that the internal temperature of the image forming apparatus 1 is higher than 10° C., the heating control unit proceeds to (D), further proceeds to Act 1201 as shown in FIG. 22, and performs driving control corresponding to internal temperature higher than 10° C. of the image forming apparatus 1. The driving control table is the driving control table shown in FIG. 24.

First, the heating control unit 52 determines, according to temperature information in the inside of the image forming apparatus 1, based on which of the driving control tables stored in the memory 54 driving control for the heating unit 21 should be performed.

Driving control for the excitation coils of the heating unit 21 corresponding to the driving control table at internal temperature equal to or lower than 10° C. of the image forming apparatus 1 is explained in detail with reference to FIG. 21.

First, in Act 1101, the temperature-information acquiring unit 51 acquires, as temperature information, the temperature of the belt 14 detected by the thermopiles 17a and 17b and sends the temperature information to the heating control unit 52. In Act 1102, the heating control unit 52 determines, on the basis of the temperature information acquired from the temperature-information acquiring unit 51, whether the temperature of the belt 14 detected by the thermopiles 17a and 17b reaches control temperature (in the fourth embodiment, 160° C.).

If it is determined in Act 1102 that the temperature of the belt 14 is equal to or lower than 160° C., first, in Act 1103, the heating control unit 52 sets an output of the excitation coils 21a and 21b of the heating unit 21 to 1100 W. Subsequently, in Act 1104, the heating control unit 52 executes, on the basis of the temperature information of the belt 14, comparison of temperatures in the center and at the ends of the belt 14 detected by the thermopiles 17a and 17b. The heating control unit 52 selects, on the basis of a result of the temperature comparison, driving time for each of temperature differences set in the driving control table and performs driving control for the excitation coils of the heating unit 21.

Specifically, processing can be performed as explained below on the basis of a driving control table shown in FIG. 23.

First, in Act 1104, the heating control unit 52 determines whether a temperature difference between the center and the ends of the belt 14 is equal to or smaller than 5° C. If it is determined that the temperature difference is equal to or smaller than 5° C., the heating control unit 52 drives each of the excitation coils 21a and 21b of the heating unit 21 for 20 ms (Act 1105). The heating control unit 52 returns to Act 1101 and repeats the processing until it is determined in Act 1102 that the temperature of the belt 14 reaches 160° C.

If it is determined in Act 1104 that the temperature difference between the center and the ends of the belt 14 is larger than 5° C., the heating control unit 52 proceeds to Act 1106 and determines whether the temperature difference between the center and the ends of the belt 14 is 5 to 10° C. If it is determined that the temperature difference is 5 to 10° C., the heating control unit 52 drives, for 60 ms, the excitation coil(s) that heats (heat) a side determined as having lower temperature among the excitation coils 21a and 21b of the heating unit 21. The heating control unit 52 drives, for 20 ms, the excitation coil(s) that heats (heat) a side determined as having higher temperature (Act 1107). The heating control unit 52 returns to Act 1101 and repeats the processing until it is determined in Act 1102 that the temperature of the belt 14 reaches 160° C.

If it is determined in Act 1106 that the temperature difference between the center and the ends of the belt 14 is larger than 10° C., the heating control unit 52 proceeds to Act 1108 and determines whether the temperature difference between the center and the ends of the belt 14 is 10 to 15° C. If it is determined that the temperature difference is 10 to 15° C., the heating control unit 52 drives, for 100 ms, the excitation coil(s) that heats (heat) a side determined as having lower temperature among the excitation coils 21a and 21b of the heating unit 21 (Act 1109). Further, the heating control unit 52 drives, for 20 ms, the excitation coil(s) that heats (heat) a side determined as having high temperature (Act 1109). Subsequently, the temperature-information acquiring unit 51 acquires temperature information of the belt 14 (Act 1110). The heating control unit 52 determines, on the basis of the acquired temperature information, whether a temperature difference between the center and the ends is equal to or smaller than 5° C. (Act 1111). If it is determined that the temperature difference between the center and the ends is larger than 5° C., the heating control unit 52 returns to Act 1109 and repeats the processing. On the other hand, if it is determined that the temperature difference between the center and the sides is equal to or smaller than 5° C., the heating control unit 52 returns to Act 1101 and repeats the processing until it is determined in Act 1102 that the temperature of the belt 14 reaches 160° C.

If it is determined in Act 1112 that the temperature difference between the center and the ends of the belt 14 is larger than 15° C., the heating control unit 52 proceeds to S1112 and determines whether the temperature difference between the center and the ends of the belt 14 is 15 to 20° C. If it is determined that the temperature difference is 15 to 20° C., the heating control unit 52 drives, for 140 ms, the excitation coil(s) that heats (heat) a side determined as having lower temperature among the excitation coils 21a and 21b of the heating unit 21 (Act 1113). Further, the heating control unit 52 drives, for 20 ms, the excitation coil(s) that heats (heat) a side determine as having high temperature (Act 1113). Subsequently, the temperature-information acquiring unit 51 acquires temperature information of the belt 14 (Act 1114). The heating control unit 52 determines, on the basis of the acquired temperature information, whether a temperature difference between the center and the ends is equal to or smaller than 5° C. (Act 1115). If it is determined that the temperature difference between the center and the ends is larger than 5° C., the heating control unit 52 returns to Act 1113 and repeats the processing. On the other hand, if it is determined that the temperature difference between the center and the ends is equal to or smaller than 5° C., the heating control unit 52 returns to Act 1101 and repeats the processing until it is determined in Act 1102 that the temperature of the belt 14 reaches 160° C.

If it is determined in Act 1112 that the temperature difference between the center and the ends of the belt 14 is larger than 20° C., the heating control unit 52 drives, for 180 ms, the excitation coil(s) that heats (heat) a side determined as having lower temperature among the excitation coils 21a and 21b of the heating unit 21 (Act 1116). Further, the heating control unit 52 drives, for 20 ms, the excitation coil(s) that heats (heat) a side determined as having higher temperature (Act 1116). Subsequently, the temperature-information acquiring unit 51 acquires temperature information of the belt 14 (Act 1117). The heating control unit 52 determines, on the basis of the acquired temperature information, whether a temperature difference between the center and the ends is equal to or smaller than 5° C. (Act 1118). If it is determined that the temperature difference between the center and the ends is larger than 5° C., the heating control unit 52 returns to Act 1116 and repeats the processing. On the other hand, if it is determined that the temperature difference between the center and the end is equal to or smaller than 5° C., the heating control unit 52 returns to Act 1101 and repeats the processing until it is determined in Act 1102 that the temperature of the belt 14 reaches 160° C.

On the other hand, if it is determined in Act 1101 that the temperature in the inside of the image forming apparatus 1 is higher than 10° C., the heating control unit 52 proceeds to Act 1201 and performs, on the basis of a flowchart shown in FIG. 22, driving control for the excitation coils of the heating unit 21 using the driving control table corresponding to temperature equal to or higher than 10° C. in the inside of the image forming apparatus 1.

First, in Act 1202, the temperature-information acquiring unit 51 acquires, as temperature information, the temperature of the belt 14 detected by the thermopiles 17a and 17b and sends the temperature information to the heating control unit 52. In Act 1202, the heating control unit 52 determines, on the basis of the temperature information acquired by the temperature-information acquiring unit 51, whether or not the temperature of the belt 14 detected by the thermopiles 17a and 17b reaches 160° C.

If it is determined in Act 1202 that the temperature of the belt 14 is equal to or lower than 160° C., first, in Act 1203, the heating control unit 52 sets an output of the heating unit 21 to 1100 W. Subsequently, in Act 1204, the heating control unit 52 executes, on the basis of the temperature information of the belt 14, comparison of temperatures in the center and at the ends of the belt 14 detected by the thermopiles 17a and 17b. The heating control unit 52 selects, on the basis of a result of the temperature comparison, driving time for each of the temperature differences set in the driving control table corresponding to temperature higher than 10° C. in the inside of the image forming apparatus 1 and performs driving control for the excitation coils 21a and 21b of the heating unit 21.

Specifically, processing can be performed as explained below on the basis of the driving control table shown in FIG. 24.

First, in Act 1204, the heating control unit 52 determines whether a temperature difference between the center and the ends of the belt 14 is equal to or smaller than 5° C. If it is determined that the temperature difference is equal to or smaller than 5° C., the heating control unit 52 drives each of the excitation coils 21a and 21b of the heating unit 21 for 20 ms (Act 1205). Subsequently, the heating control unit 52 returns to Act 1201 and repeats the processing until it is determined in Act 1202 that the temperature of the belt 14 reaches 160° C.

If it is determined in Act 1204 that the temperature difference between the center and the ends of the belt 14 is larger than 5° C., the heating control unit 52 proceeds to Act 1206 and determines whether the temperature difference between the center and the ends of the belt 14 is 5 to 10° C. If it is determined that the temperature difference is 5 to 10° C., the heating control unit 52 drives, for 40 ms, the excitation coil(s) that heats (heat) a side determined as having lower temperature among the excitation coils 21a and 21b of the heating unit 21. The heating control unit 52 drives, for 20 ms, the excitation coil(s) that heats (heat) a side determined as having higher temperature (Act 1207). The heating control unit 52 returns to Act 1201 and repeats the processing until it is determined in Act 1202 that the temperature of the belt 14 reaches 160° C.

If it is determined in Act 1206 that the temperature difference between the center and the ends of the belt 14 is larger than 10° C., the heating control unit 52 proceeds to Act 1208 and determines whether the temperature difference between the center and the ends of the belt 14 is 10 to 15° C. If it is determined that the temperature difference is 10 to 15° C., the heating control unit 52 drives, for 80 ms, the excitation coils that heat the side determined as having lower temperature among the excitation coils 21a and 21b of the heating unit 21 (Act 1209). Further, the heating control unit 52 drives, for 20 ms, the excitation coil that heats the side determined as having higher temperature (Act 1209). Subsequently, the temperature-information acquiring unit 51 acquires temperature information of the belt 14 (Act 1210). The heating control unit 52 determines, on the basis of the acquired temperature information, whether a temperature difference between the center and the ends is equal to or smaller than 5° C. (Act 1211). If it is determined that the temperature difference between the center and the ends is larger than 5° C., the heating control unit 52 returns to Act 1209 and repeats the processing. On the other hand, if it is determined that the temperature difference between the center and the ends is equal to or smaller than 5° C., the heating control unit 52 returns to Act 1201 and repeats the processing until it is determined in Act 1202 that the temperature of the belt 14 reaches 160° C.

If it is determined in Act 1208 that the temperature difference between the center and the ends of the belt 14 is larger than 15° C., the heating control unit 52 proceeds to Act 1212 and determines whether the temperature difference between the center and the ends of the belt 14 is 15 to 20° C. If it is determined that the temperature difference between the center and the ends is 15 to 20° C., the heating control unit 52 drives, for 100 ms, the excitation coils that heat the side determined as having lower temperature among the excitation coils 21a and 21b of the heating unit 21 (Act 1213). Further, the heating control unit 52 drives, for 20 ms, the excitation coil that heats the side determined as having higher temperature (Act 1213). Subsequently, the temperature-information acquiring unit 51 acquires temperature information of the belt 14 (Act 1214). The heating control unit 52 determines, on the basis of the acquired temperature information, whether a temperature difference between the center and the ends is equal to or smaller than 5° C. (Act 1215). If it is determined that the temperature difference between the center and the ends of the belt 14 is larger than 5° C., the heating control unit 52 returns to Act 1213 and repeats the processing. On the other hand, if it is determined that the temperature difference between the center and the ends is equal to or smaller than 5° C., the heating control unit 52 returns to Act 1201 and repeats the processing until it is determined in Act 1202 that the temperature of the belt 14 reaches 160° C.

If it is determined in Act 1212 that the temperature difference between the center and the ends of the belt 14 is larger than 20° C., the heating control unit 52 drives, for 120 ms, the excitation coil(s) that heats (heat) a side determined as having lower temperature among the excitation coils 21a and 21b of the heating unit 21 (Act 1216). Further, the heating control unit 52 drives, for 20 ms, the excitation coil(s) that heats (heat) a side determined as having higher temperature (Act 1216). Subsequently, the temperature-information acquiring unit 51 acquires temperature information of the belt 14 (Act 1217). The heating control unit 52 determines, on the basis of the acquired temperature information, whether a temperature difference between the center and the ends is equal to or smaller than 5° C. (Act 1218). If it is determined that the temperature difference between the center and the ends is larger than 5° C., the heating control unit 52 returns to Act 1216 and repeats the processing. On the other hand, if it is determined that the temperature difference between the center and the end is equal to or smaller than 5° C., the heating control unit 52 returns to Act 1201 and repeats the processing until it is determined in Act 1202 that the temperature of the belt 14 reaches 160° C.

As a result of performing the processing explained above, even when internal temperature of the image forming apparatus 1 in the paper passing state is lower than usual, it is possible to keep temperature distribution in the rotation axis direction on the belt 14 substantially constant.

### Fifth Embodiment

In the embodiments explained above, the position of the thermopiles is near the belt surface of the belt 14 (FIG. 2). However, the position of the thermopiles is not limited to this. It is also possible to arrange the thermopiles in other positions.

In a fifth embodiment of the present invention, the thermopiles 17a and 17b arranged near the belt surface of the belt 14 in the first embodiment are arranged in a position near the heating roller 11.

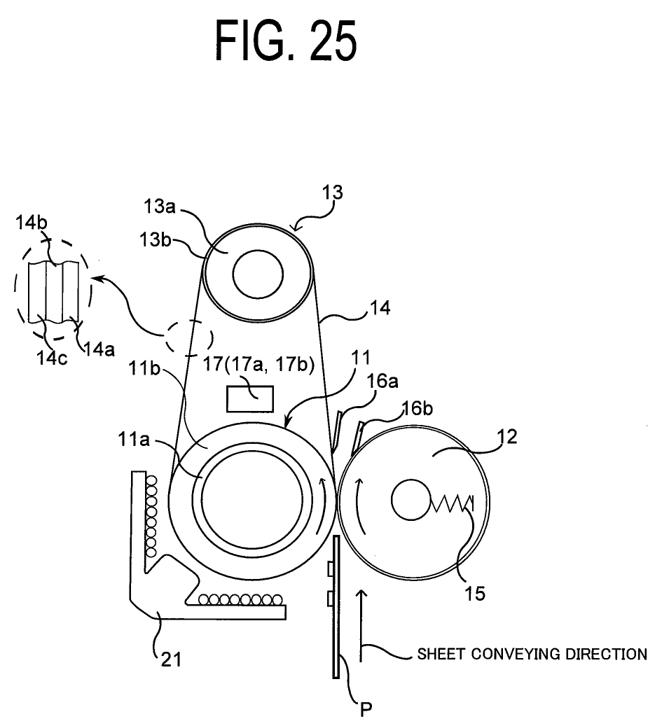

As shown in FIG. 25, in a fixing device according to the fifth embodiment, the thermopiles 17a and 17b are arranged in a position near a roller surface of the heating roller 11 and detect surface temperature of areas on the heating roller 11 corresponding to plural areas of the belt 14, for example, areas corresponding to the center and the ends of the belt 14. The temperature-information acquiring unit 51 acquires the surface temperature as temperature information of the belt 14.

### Sixth Embodiment

In a sixth embodiment of the present invention, the thermopiles 17a and 17b arranged near the belt surface of the belt 14 in the first embodiment are arranged in a position near the pressing roller 12.

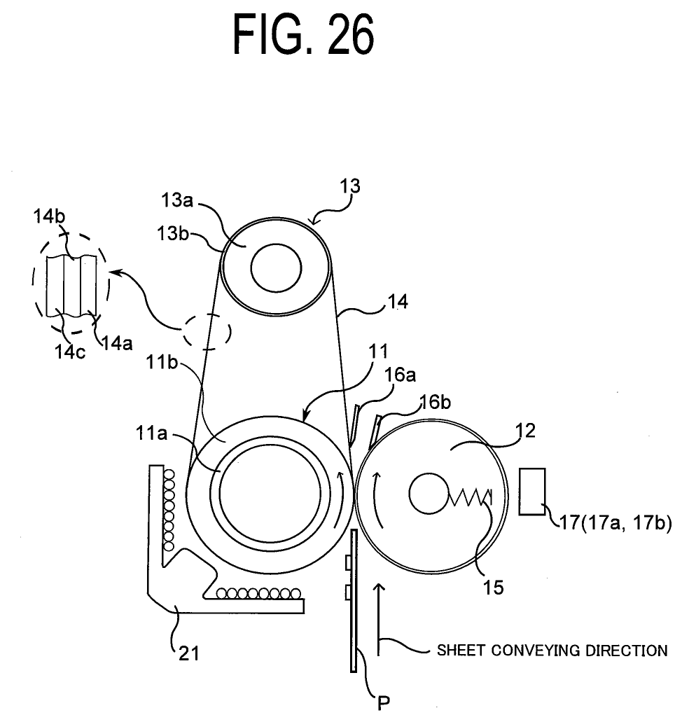

As shown in FIG. 26, in a fixing device according to the sixth embodiment, the thermopiles 17a and 17b are arranged in a position near a roller surface of the pressing roller 12 and detect surface temperature of areas on the pressing roller 12 corresponding to plural areas of the belt 14, for example, areas corresponding to the center and the ends of the belt 14. The temperature-information acquiring unit 51 acquires the surface temperature as temperature information of the belt 14.

### Seventh Embodiment

In the first to sixth embodiments, the heating device 7 includes the stretching and suspending roller 13 and the belt 14. However, the present invention is not limited to this. As shown as a seventh embodiment of the present invention, the stretching and suspending roller 13 and the belt 14 may be removed from the fixing device 7 according to the first to sixth embodiments.

Specifically, the fixing device 7 can be configured to include the heating roller 11, the pressing roller 12, the heating unit 21 including the excitation coils 21a and 21b, the thermopiles 17a and 17b, the temperature-information acquiring unit 51, the heating control unit 52, and the operation-state acquiring unit 53. The temperature-information acquiring unit 51 acquires temperature information in the rotation axis direction of the heating roller 11. The heating control unit 52 performs, on the basis of the temperature information, driving control for the excitation coils 21a and 21b in the same manner as the first to fourth embodiments to thereby perform temperature control in the rotation axis direction of the heating roller 11.

As in the fifth and sixth embodiments, the position of the thermopiles 17a and 17b can be set in a position near the heating roller 11 or a position near the pressing roller 12.

The present invention has been explained with reference to the embodiments. However, the present invention is not limited to the embodiments and various modifications are possible.

The operations in the processing in the fixing device are realized by causing the CPU 45 to execute a temperature control program stored in the memory 54.

A computer program for causing a computer configuring the fixing device to execute the operations explained above can be provided as the temperature control program. In the example explained in the first to fourth embodiment, the computer program for realizing the functions for carrying out the present invention is recorded in advance in a storage area provided in the device. However, present invention is not limited to this. The same computer program may be downloaded from a network to the device or the same program stored in a computer-readable recording medium may be installed in the device. A form of the recording medium may be any form as long as the recording medium can store the computer program and can be read by the computer. Specifically, examples of the recording medium include internal storage devices implemented in the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. Functions obtained by the installation and the download in this way may realize the functions in cooperation with an OS (operating system) in the apparatus.

The program in this embodiment includes a program for dynamically generating an execution module.

The present invention has been explained in detail with reference to the specific forms. However, it would be obvious for those skilled in the art that various modifications and alterations are possible without departing from the spirit and the scope of the present invention.

As explained above in detail, according to the present invention, it is possible to provide a fixing device that can keep temperature distribution in a rotation axis direction of a heating member such as a belt or a heating roller substantially constant.

What is claimed is:

1. A fixing device comprising:
a heating roller;
a stretching and suspending roller that rotates around a rotation axis parallel to a rotation axis of the heating roller;
a belt wound and suspended around the heating roller and the stretching and suspending roller;
a pressing roller that nips and conveys, in cooperation with the belt, a sheet having a developer image formed thereon and heats and fixes the developer image on the sheet;
plural heaters that heat plural areas different from one another in the rotation axis direction on the belt;
a temperature-information acquiring unit that acquires temperature information concerning temperatures of areas on the belt heated by at least two among the plural heaters; and
a heating control unit that alternately drives the respective plural heaters and sets, on the basis of the information acquired by the temperature-information acquiring unit, driving time for the heater that heats a second area having temperature lower than that of a first area among the plural areas longer than driving time for the heater that heats the first area.

2. The device according to claim 1, wherein
the device is provided in an image forming apparatus,
the device further includes an operation-information acquiring unit that acquires information concerning an operation state of the image forming apparatus, and
the heating control unit selects, as driving time for the heater that heats the second area, driving time associated with the information acquired by the operation-information acquiring unit among plural kinds of driving times set as driving time for the heater that heats the second area.

3. The device according to claim 2, wherein the heating control unit sets each of the plural kinds of driving times set as the driving time for the heater that heats the second area longer as an operation state associated with the driving time has a larger degree of causing a temperature difference among the plural areas in the rotation axis direction on the belt.

4. The device according to claim 1, wherein the heating control unit sets a time difference between the driving time for the heater that heats the first area and the driving time for the heater that heats the second area larger as a temperature difference between the first area and the second area is larger.

5. The device according to claim 1, wherein the driving times for the heaters are equal to or longer than 1/H when a half period of an electric current used for driving the heaters is represented as H.

6. The device according to claim 1, further comprising plural sensors that are arranged in a position near a roller surface of the heating roller and detect surface temperatures of areas on the heating roller corresponding to at least two areas among the plural areas, wherein
the temperature-information acquiring unit acquires, as the temperature information, the temperatures detected by the plural sensors.

7. The device according to claim 1, further comprising plural sensors that are arranged in a position near a roller surface of the pressing roller and detect surface temperatures of areas on the pressing roller corresponding to at least two areas among the plural areas, wherein
the temperature-information acquiring unit acquires, as the temperature information, the temperatures detected by the plural sensors.

8. The device according to claim 1, further comprising plural sensors that are arranged in a position near a belt surface of the belt and detect surface temperatures of areas on the belt corresponding to at least two areas among the plural areas, wherein
the temperature-information acquiring unit acquires, as the temperature information, the temperatures detected by the plural sensors.

9. A fixing device comprising:
a heating roller;
a pressing roller that nips and conveys, in cooperation with the roller, a sheet having a developer image formed thereon and heats and fixes the developer image on the sheet;
plural heaters that heat plural areas different from one another in a rotation axis direction of the heating roller;
a temperature-information acquiring unit that acquires temperature information concerning temperatures of areas on the heating roller heated by at least two among the plural heaters; and
a heating control unit that alternately drives the respective plural heaters and sets, on the basis of the information acquired by the temperature-information acquiring unit, driving time for the heater that heats a second area having temperature lower than that of a first area among the plural areas longer than driving time for the heater that heats the first area.

10. The device according to claim 9, wherein
the device is provided in an image forming apparatus,
the device further includes an operation-information acquiring unit that acquires information concerning an operation state of the image forming apparatus, and
the heating control unit selects, as driving time for the heater that heats the second area, driving time associated with the information acquired by the operation-information acquiring unit among plural kinds of driving times set as driving time for the heater that heats the second area.

11. The device according to claim 10, wherein the heating control unit sets each of the plural kinds of driving times set as the driving time for the heater that heats the second area longer as an operation state associated with the driving time has a larger degree of causing a temperature difference among the plural areas in the rotation axis direction of the heating roller.

12. The device according to claim 9, wherein the heating control unit sets a time difference between the driving time for the heater that heats the first area and the driving time for the heater that heats the second area larger as a temperature difference between the first area and the second area is larger.

13. The device according to claim 9, wherein the driving times for the heaters are equal to or longer than 1/H when a half period of an electric current used for driving the heaters is represented as H.

14. The device according to claim 9, further comprising plural sensors that are arranged in a position near a roller surface of the heating roller and detect surface temperatures of areas on the heating roller corresponding to at least two areas among the plural areas, wherein
the temperature-information acquiring unit acquires, as the temperature information, the temperatures detected by the plural sensors.

15. The device according to claim 9, further comprising plural sensors that are arranged in a position near a roller surface of the pressing roller and detect surface temperatures of areas on the pressing roller corresponding to at least two areas among the plural areas, wherein
the temperature-information acquiring unit acquires, as the temperature information, the temperatures detected by the plural sensors.

16. A temperature control method in a fixing device including a heating roller, a stretching and suspending roller that rotates around a rotation axis parallel to a rotation axis of the heating roller, a belt wound and suspended around the heating roller and the stretching and suspending roller, a pressing roller that nips and conveys, in cooperation with the belt, a sheet having a developer image formed thereon and heats and fixes the developer image on the sheet, and plural heaters that heat plural areas different from one another in the rotation axis direction on the belt, the temperature control method comprising:
acquiring temperature information concerning temperatures of areas on the heating roller heated by at least two among the plural heaters; and
alternately driving the respective plural heaters and setting, on the basis of the acquired temperature information, driving time for the heater that heats a second area having temperature lower than that of a first area among the plural areas longer than driving time for the heater that heats the first area.

17. The method according to claim 16, wherein
the fixing device is provided in an image forming apparatus,
the method further includes:
acquiring information concerning an operation state of the image forming apparatus; and
selecting, as driving time for the heater that heats the second area, driving time associated with the acquired information among plural kinds of driving times set as driving time for the heater that heats the second area.

18. The method according to claim 17, further comprising setting each of the plural kinds of driving times set as the driving time for the heater that heats the second area longer as an operation state associated with the driving time has a larger degree of causing a temperature difference among the plural areas in the rotation axis direction on the belt.

19. The method according to claim 16, further comprising setting a time difference between the driving time for the heater that heats the first area and the driving time for the heater that heats the second area larger as a temperature difference between the first area and the second area is larger.

20. The method according to claim 16, wherein the driving times for the heaters are equal to or longer than 1/H when a half period of an electric current used for driving the heaters is represented as H.
